(19) United States
(12) Patent Application Publication
(10) Pub. No.: US 2026/0371307 A1
(43) Pub. Date: Nov. 19, 2026

(54) AUTOMATIC LABEL GENERATION FOR POSITIONING TRAINING DATA IN A NETWORK-BASED POSITIONING SYSTEM

(71) Applicant: Telefonaktiebolaget LM Ericsson (PUBL), Stockholm (SE)

(72) Inventors: Atieh Rajabi Khamesi, Newark, CA (US); Jung-Fu Cheng, Fremont, CA (US); Yufei Blankenship, Kildeer, IL (US)

(21) Appl. No.: 19/154,441

(22) PCT Filed: Feb. 9, 2024
(86) PCT No.: PCT/IB2024/051241

§ 371 Date: Aug. 7, 2025

Related U.S. Application Data
(60) Provisional application No. 63/444,832, filed on Feb. 10, 2023.
(60) Provisional application No. 63/444,853, filed on Feb. 10, 2023.

(51) Int. Cl. H04W 64/00; H04W 24/10

(52) U.S. Cl. CPC H04W 64/006; H04W 24/10

(57) ABSTRACT

A method (2000) by a first network node (1110, 506) for improved UE positioning includes generating (2002) at least one positioning related report associated with at least one machine learning, ML, model. The first network node transmits (2004) the at least one positioning related report to a second network node (1110, 502) operating as a position generation entity. The first network node receives (2006), from the second network node, feedback indicating a quality level of the at least one positioning related report. The first network node performs (2008) at least one operation based on the feedback indicating the quality level of the at least one positioning related report.

### TECHNICAL FIELD

The present disclosure relates, in general, to wireless communications and, more particularly, systems and methods for automatic label generation for positioning training data in a network-based positioning system.

### BACKGROUND

Artificial Intelligence (AI) and Machine Learning (ML) have been investigated as promising tools to optimize the design of air-interface in wireless communication networks in both academia and industry. Example use cases include using autoencoders for Channel State Information (CSI) compression to reduce the feedback overhead and improve channel prediction accuracy; using deep neural networks for classifying Line of Sight (LoS) and Non-Line of Sight (NLoS) conditions to enhance the positioning accuracy; using reinforcement learning for beam selection at the network side and/or the User Equipment (UE) side to reduce the signaling overhead and beam alignment latency; and using deep reinforcement learning to learn an optimal precoding policy for complex Multiple Input Multiple Output (MIMO) precoding problems.

Building an AI/ML model includes several development steps where the actual training of the AI model is just one step in a training pipeline. An important part in AI/ML developing is the AI/ML model lifecycle management.

FIG. 1 illustrates training and inference pipelines, and their interactions within a model lifecycle management procedure. The AI model lifecycle management typically consists of:
A training (re-training) pipeline:
   Data ingestion refers to gathering raw (training) data from a data storage. After data ingestion, there may also be a step that controls the validity of the gathered data.
   Data pre-processing refers to some feature engineering applied to the gathered data. For example, it may include data normalization and possibly a data transformation required for the input data to the AI/ML model.
   Model training steps.
   Model evaluation refers to benchmarking the performance to some baseline. The iterative steps of model training and model evaluation continues until the acceptable level of performance is achieved.
   Model registration refers to registering the AI/ML model, including any corresponding AI/ML-meta data that provides information on how the AI/ML model was developed and possibly AI/ML model evaluations performance outcomes.
A deployment stage makes the trained (or re-trained) AI/ML model part of the inference pipeline.
An inference pipeline:
   Data ingestion refers to gathering raw (inference) data from a data storage.
   Data pre-processing stage is typically identical to corresponding processing that occurs in the training pipeline.
   Model operational refers to using the trained and deployed model in an operational mode.
   Data & model monitoring refers to validating that the inference data are from a distribution that aligns well with the training data, as well as monitoring model outputs for detecting any performance, or operational, drifts.
A drift detection stage informs about any drifts in the model operations.

If the operating environment is found to drift too much from that of the training dataset, the model will need to be retrained or retuned in order to operate in this new environment properly.

User Equipment (UE) positioning is the core of location-based services and has variety of commercial applications from entertainment to healthcare and geo-targeting advertisement to smart factories and smart warehouses. Moreover, with the advent of extended Reality (XR), UE positioning has become more important. The requirement for positioning accuracy varies among different applications. For example, the requirement for positioning accuracy for industrial applications may be from a centimeter level, while the requirement for emergency calls may be to a few meters accuracy.

In 3GPP TS 36.305, a list of positioning techniques are provided. A few representative methods are described below:
Enhanced Cell Identifier (ID): This technique uses the cellular network's knowledge of information relating to the serving cell of the UE (i.e., cell ID and other information) to determine the position.
Assisted Global Navigation Satellite System (GNSS): The UE retrieves GNSS information to determine its position.
Observed Time Difference of Arrival (OTDoA): Using this technique, the UE estimates the time difference of reference signals from different base stations and report this information to the network for multilateration.
Uplink Time Difference of Arrival (UTDoA): This technique uses the received signals from the UE at multiple known positions such as, for example, gNBs, to estimate the relative Timing of Arrival (ToA) at different Transmit/Receive Points (TRPs) and then performs the multilateration computation at the network side to obtain an estimated UE position.

Current signal processing techniques can generally be applied by the UE, BS, or TRP to generate positioning related reports in operating environments with enough line-of-sigh (LoS) links. To proceed, the ToA is used as the main example. With the known speed of the radio wave, the ToA estimates can be converted to 3D distance estimates between the Transmit/Transmission/Transmitter (TX) and Receive/Reception/Receiver (RX) nodes.

In a radio environment, a transmitted signal may travel directly from the transmitter to the receiver resulting in a LoS path. However, the transmitted signal can also be reflected or scattered by the environment resulting in multiple NLoS paths. For example, FIG. 2 illustrates a multipath radio environment between a UE and two TRPs. For TRP A, a LoS path exists between the UE's transmitter and TRP A's receiver. For TRP B, however, only NLoS paths exist between the UE's transmitter and TRP B's receiver because of the blockers in the environment.

For a LoS path, conventional signal processing techniques can be applied to obtained accurate ToA estimates as the timing of the first observed path in the received signal. For these LoS paths, the ToAs represent the correct representation of the 3D distance between the TX and RX, d_{3D}, via the speed of the radio wave, c:

$${ToA}_{LoS} = \frac{{d}_{3 D}}{c}$$

However, for NLoS paths as illustrated in FIG. 2, the radio wave travels indirect path to arrive at the RX via potentially more than one reflection. Hence, the straightforward estimate of the ToA as the first observed path in the received signal will give incorrect estimate of the 3D distance between TX and RX:

$${ToA}_{NLoS} > \frac{{d}_{3 D}}{c}$$

FIGS. 3A and 3B illustrate example magnitudes of LoS and NLoS channel impulse responses (CIRs), respectively. More specifically, FIGS. 3A and 3B illustrate the first observed path ToA, τ_{obs}, as the delay of the first path in the received CIRs for a LoS and a NLoS example in a InF-DH {40%, 2 m, 2 m} radio environment. More specifically, the first observed path ToA for the LoS example illustrated in FIG. 3A may be calculated as:

LoS exampleτ_{obs}=τ_{dp}=18.5 taps

The first observed path ToA illustrated for the NLoS example illustrated in FIG. 3B may be calculated as:

NLoS exampleτ_{obs}=79.4>τ_{dp}=30.2 taps

Using these over-estimated ToAs or equivalently 3D distances in conventional positioning solutions based on triangulation computation will result in incorrect localization of the UE position.

In addition, AI/ML models can be adopted to infer the correct direct path ToA from the received signals regardless of whether the signals arrive via LoS or NLoS paths:

$${ToA}_{DP} {=}^{Δ} \frac{{d}_{3 D}}{c}$$

That is, the direct path ToA is the time for the radio wave to travel directly from the TX to the RX and ignores any potential blockers in between.

Such types of AI/ML models perform what is also known as fingerprinting of the radio environment. That is, via training with enough data, the AI/ML models obtain understanding the correspondence of the received signals and the radio environment. If the radio environment remains static or changes only slightly, the AI/ML models can continue to produce correct or correct enough ToA estimates for the conventional positioning algorithms to compute UE positions within accuracy requirement. However, the AI/ML models may produce inadequate ToA estimates for accurate positioning if the radio environment changes too much over time. It is hence important to monitor the AI/ML model performance over time to identify whether updating or retraining of the AI/ML models is needed.

There currently exist certain challenge(s), however. For example, it has become necessary to perform costly and time-consuming campaign of collecting new and/or more training data in the new operating environment in order to retrain or retune the ML models.

### SUMMARY

Certain aspects of the disclosure and their embodiments may provide solutions to these or other challenges. For example, according to certain embodiments, methods and systems disclosed herein automatically compile useful new training dataset from normal positioning operations.

According to certain embodiments, a method by a first network node for improved UE positioning includes generating at least one positioning related report associated with at least one machine learning, ML, model. The first network node transmits the at least one positioning related report to a second network node operating as a position generation entity. The first network node receives, from the second network node, feedback indicating a quality level of the at least one positioning related report. The first network node performs at least one operation based on the feedback indicating the quality level of the at least one positioning related report.

According to certain embodiments, a first network node for improved UE positioning is configured to generate at least one positioning related report associated with at least one machine learning, ML, model. The first network node is configured to transmit the at least one positioning related report to a second network node operating as a position generation entity. The first network node is configured to receive, from the second network node, feedback indicating a quality level of the at least one positioning related report. The first network node is configured to perform at least one operation based on the feedback indicating the quality level of the at least one positioning related report.

According to certain embodiments, a method by a second network node operating as a position generating entity for improved assisted positioning includes receiving, from a first network node operating as a position related report generation entity, a first set of positioning related reports generated based on at least one wireless signal transmitted on a downlink channel. Based on the first set of positioning related reports, the second network node determines a location of a UE. The second network node transmits feedback to the first network node operating as the position related report generation entity. The feedback indicates a quality of the at least one positioning related report.

According to certain embodiments, a second network node operating as a position generating entity for improved assisted positioning is configured to receive, from a first network node operating as a position related report generation entity, a first set of positioning related reports generated based on at least one wireless signal transmitted on a downlink channel. Based on the first set of positioning related reports, the second network node is configured to determine a location of a UE. The second network node is configured to transmit feedback to the first network node operating as the position related report generation entity. The feedback indicates a quality of the at least one positioning related report.

Certain embodiments may provide one or more of the following technical advantage(s). For example, certain embodiments may provide a technical advantage of automatically compiling useful new training dataset from normal positioning operations. This eliminates or reduces the need to perform extensive dedicated campaign of new training data collection. This allows the AI/ML model to be trained and updated incrementally to so that the model can adapt to gradual environmental change, and continue to provide accurate location estimation of target UEs in the deployed environment.

As another example, certain embodiments may provide a technical advantage of using the automatically compiled new training dataset to perform continuous training or tuning of the ML models. As such, the models will automatically follow or capture the changing characteristics of the operating environment. Accordingly, a further technical advantage of certain embodiments may be improved reliability of the ML models in such time varying operating environment.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates training and inference pipelines, and their interactions within a model lifecycle management procedure;

FIG. 2 illustrates a multipath radio environment between a UE and two TRPs;

FIGS. 3A and 3B illustrate example magnitudes of LoS and NLoS CIRs, respectively;

FIG. 4 illustrates a positioning architecture in 5GS, according to certain embodiments;

FIG. 5 illustrates an example method performed by the position generation entity, according to certain embodiments;

FIG. 6 illustrates an example iterative method performed by the position generation entity, according to certain embodiments;

FIG. 7 illustrates an example of ideal trilateration in a 2D space, according to certain embodiments;

FIG. 8 illustrates one such example of trilateration with inaccurate positioning reports, according to certain embodiments;

FIG. 9 illustrates an example high-level architecture where the position generation entity (Node B) provides positioning related labels to the positioning related training data collection entity (Node C), according to certain embodiments;

FIG. 10 illustrates another example high-level architecture with the model updating functionality realized by a Node D, according to certain embodiments;

FIG. 11 illustrates another example architecture where the location method is UE-assisted and Location Management Function-based, according to certain embodiments;

FIG. 12 illustrates another example architecture where the location method is UE-based, according to certain embodiments;

FIG. 13 illustrates another example architecture where a single gNB acts as both the Positioning related report generation entity (Node A) and the Position generation entity (Node B), where split architecture is used in the gNB, according to certain embodiments;

FIG. 14 illustrates another example architecture where position generation entity (Node B) 902 provides quality feedback on positioning related report to positioning related report generation entity (Node A), according to certain embodiments;

FIG. 15 illustrates an example communication system, according to certain embodiments;

FIG. 16 illustrates an example UE, according to certain embodiments;

FIG. 17 illustrates an example network node, according to certain embodiments;

FIG. 18 illustrates a block diagram of a host, according to certain embodiments;

FIG. 19 illustrates a virtualization environment in which functions implemented by some embodiments may be virtualized, according to certain embodiments;

FIG. 20 illustrates a host communicating via a network node with a UE over a partially wireless connection, according to certain embodiments;

FIG. 21 illustrates an example method by a UE or a network node for improved UE positioning, according to certain embodiments;

FIG. 22 illustrates another method by a UE for improved UE positioning, according to certain embodiments;

FIG. 23 illustrates another method by a network node for improved UE positioning, according to certain embodiments;

FIG. 24 illustrates another method by a UE for improved positioning, according to certain embodiments; and

FIG. 25 illustrates a method by a network node operating as a position generating entity for improved positioning, according to certain embodiments.

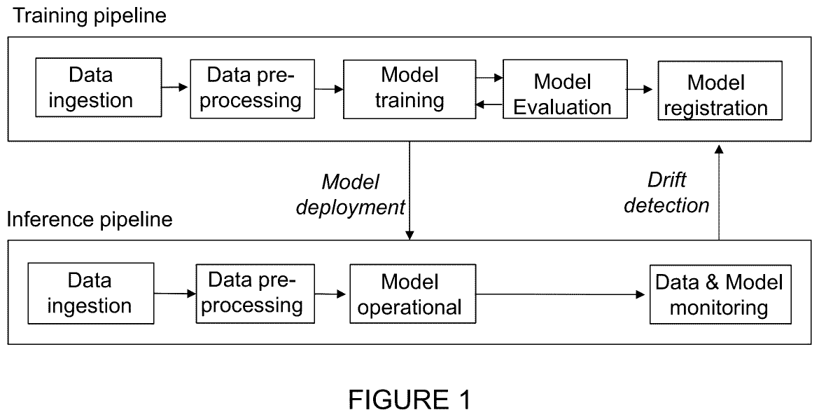

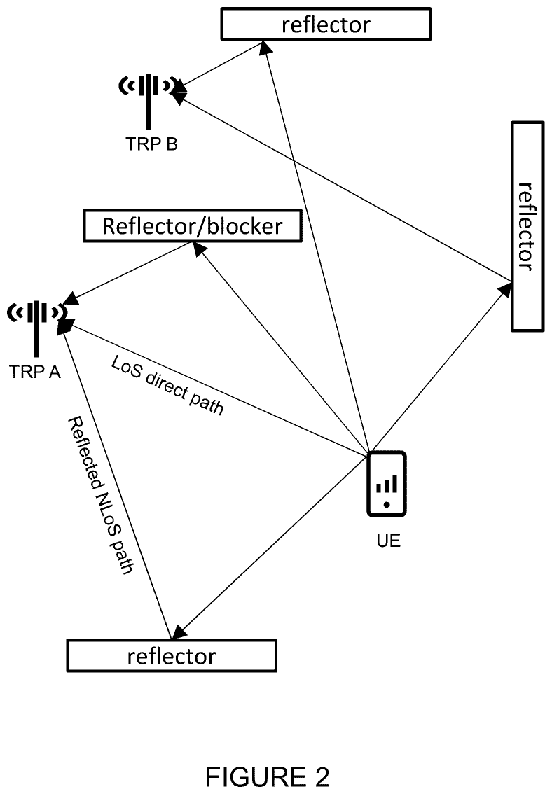

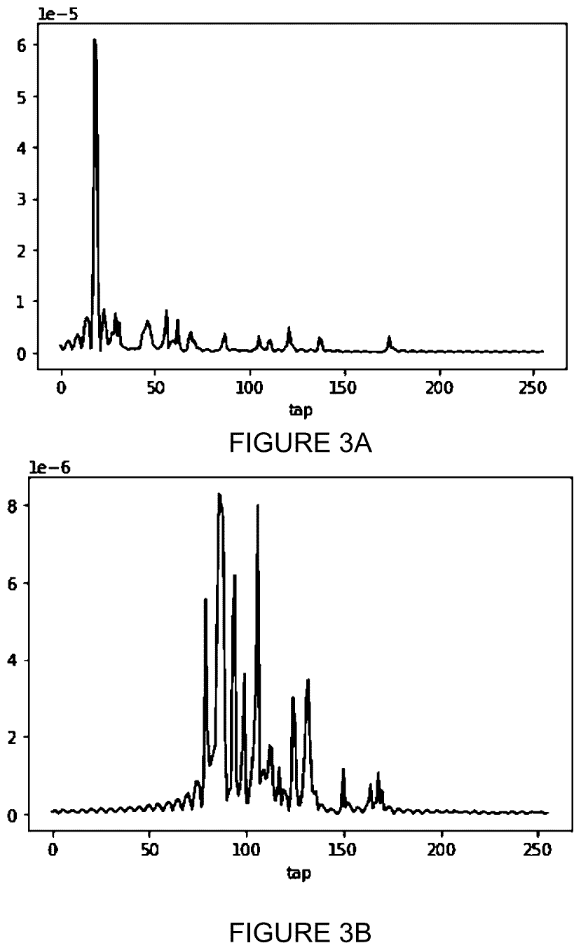

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc. The terms network node and radio network node are used interchangeably herein.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of downlink (DL) physical signals are reference signal (RS) such as Primary Synchronization Signal (PSS), Secondary Synchronization Signal (SSS), Channel State Information-Reference Signal (CSI-RS), Demodulation Reference Signal (DMRS) signals in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity (e.g., 20 ms, 40 ms, etc.). The RS may also be aperiodic.

Each SSB carries New Radio-Primary Synchronization Signal (NR-PSS), New Radio-Secondary Synchronization Signal (NR-SSS) and New Radio-Physical Broadcast Channel (NR-PBCH) in four successive symbols. One or multiple Synchronization Signal Blocks (SSBs) are transmitted in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN) etc. Therefore, SMTC occasion may also occur with certain periodicity (e.g., 5 ms, 10 ms, 20 ms, 40 ms, 80 ms, and 160 ms). Examples of uplink (UL) physical signals are reference signals such as Sounding Reference Signals (SRS), Demodulation Reference Signals (DMRS), etc. The term physical channel refers to any channel carrying higher layer information e.g. data, control etc. Examples of physical channels are Physical Broadcast Channel (PBCH), Physical Downlink Control Channel (PDCCH), Physical Downlink Shared Channel (PDSCH), Physical Uplink Shared Channel (PUSCH), Physical Uplink Control Channel (PUCCH), Physical Uplink Shared Channel (PUSCH), Short PUSCH (sPUCCH), Short PDSCH (SPDSCH), Short PUCCH (sPUCCH), Short PUSCH (sPUSCH), MTC PDCCH (MPDCCH), Narrowband PBCH (NPBCH), Narrowband PDCCH (NPDCCH), Narrowband PDSCH (NPDSCH), Narrowband PUSCH (NPUSCH), Enhanced PDCCH (E-PDCCH), etc.

The term time resource used herein may correspond to any type of physical resource or radio resource expressed in terms of length of time. Examples of time resources are symbol, time slot, subframe, radio frame, transmission time interval (TTI), interleaving time, slot, sub-slot, mini-slot, system frame number (SFN) cycle, hyper-SFN (H-SFN) cycle, etc.

According to certain embodiments, methods and systems disclosed herein automatically compile useful new training dataset from normal positioning operations. For example, according to certain embodiments, systems and methods for UE positioning use an initial position estimate based on a first set of positioning related reports to rate the compatibility scores of different positioning related reports. In a particular embodiment, a positioning related report is identified as below expected quality if its compatibility score is not better than a threshold. The corresponding ML model that generates said identified positioning related report is also identified as needing potential retraining or retuning. The network node that performs said identified ML model is notified to retain the input data used to generate said identified positioning related report. A new target positioning related report label for said retained input data used to generate said identified positioning related report is computed. Said retained input data and said new target positioning related report label for said retained input data are combined as a new training sample for said identified ML model.

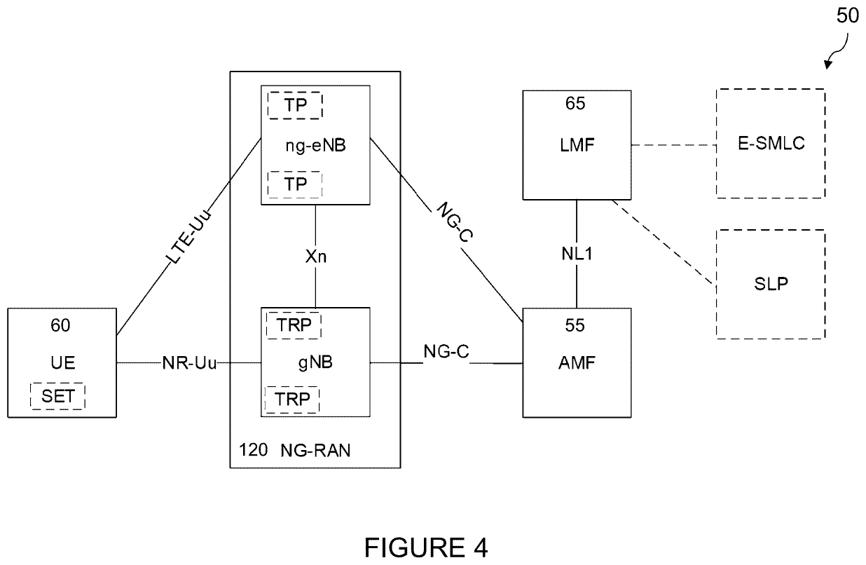

FIG. 4 illustrates a positioning architecture 50 in 5GS, according to certain embodiments. It is applicable to positioning of a UE for with New Radio (NR) or E-UTRA access.

The AMF 55 receives a request for some location service associated with a particular target UE 60 from another entity (e.g., GMLC or UE) or the AMF 55 itself decides to initiate some location service on behalf of a particular target UE 60 (e.g., for an IMS emergency call from the UE). The AMF 55 then sends a location services request to an LMF 65. The LMF 65 processes the location services request which may include transferring assistance data to the target UE 60 to assist with UE-based and/or UE-assisted positioning and/or may include positioning of the target UE 60. The LMF 65 then returns the result of the location service back to the AMF 55 (e.g., a position estimate for the UE 60). In the case of a location service requested by an entity other than the AMF 55 (e.g., a GMLC or UE), the AMF 55 returns the location service result to this entity.

An NG-RAN node 70 may control several TRPs/TPs, such as remote radio heads, or DL-PRS-only TPs for support of PRS-based TBS. In case of split gNB architecture, a gNB-DU may include TRP functionality.

The most important signalling protocols to support UE positioning include:
The UE-terminated protocols:
   LTE Positioning Protocol (LPP)
   Radio Resource Control (RRC) for NR.
The NG-RAN Node terminated protocol: NR Positioning Protocol A (NRPPa).

The LTE Positioning Protocol (LPP) is terminated between a target device and a positioning server. In the context of 3GPP UE positioning, the target device is the UE 60 (or sometimes referred to as target UE), and the positioning server is the LMF 65. LPP messages are carried as transparent PDUs across intermediate network interfaces using the appropriate protocols. The operations supported by the LPP procedure include:
Exchange of positioning capabilities;
Transfer of assistance data;
Transfer of location information (positioning measurements and/or position estimate);
Error handling;

The NRPPa protocol is between an LMF 65 and NG-RAN Node 70. In case of a split gNB architecture, the NRPPa protocol is terminated at the gNB-CU, and the F1 interface is used to support the exchange of positioning information between the gNB-DU and the gNB-CU. There are two types of NRPPa procedures:
UE associated procedure, i.e. transfer of information for a particular UE, including the procedures supporting the Positioning Information Transfer;
Non UE associated procedure, i.e. transfer of information applicable to the NG-RAN node and associated TRP, including the procedures supporting the OTDOA Information Transfer, Assistance Information Transfer, TRP Information Transfer, and Measurement Information Transfer functions.

The RRC protocol for NR is terminated between the gNB and the UE. It provides transport for LPP messages over the NR-Uu interface. Additionally, it supports transfer of measurements that may be used for positioning purposes. The RRC protocol for NR is also used to configure UEs with a sounding reference signal (SRS) for SRS transmission in RRC_CONNECTED and RRC_INACTIVE to support NG-RAN measurements for NR positioning, and configurations for DL-PRS measurement at the UE.

A multitude of positioning related reports are provided to the position generation entity by at least one positioning related report generation entity. Herein, general positioning related reports may include at least one of the following:
ToA of a DL signal or an UL signal,
TDoA of DL signals or UL signals such as, for example, DL reference signal time difference (DL RSTD), and UL Relative Time of Arrival (T_{UL-RTOA}),
Timing Advance (T_{ADV}),
DL or UL angle of departure (AoD),
DL or UL angle of arrival (AoA),
Reference signal received power (RSRP) such as, for example, DL-Positioning Reference Signal-Reference Signal Received Power (DL PRS-RSRP), and UL-Sounding Reference Signal-Reference Signal Received Power (UL SRS-RSRP),
Reference Signal Received Path Power (RSRPP) such as, for example, DL-PRS-Reference Signal Received Path Power (DL PRS-RSRPP) and UL-SRS-Reference Signal Received Path Power (UL SRS-RSRPP),
Cell ID and TRP related information (e.g., Reference Signal (RS) resource and/or resource set ID),
Carrier phase difference, and/or
Round-trip time (RTT) measurement, which is obtained by combining gNB Rx−Tx time difference and UE Rx−Tx time difference.

Though certain embodiments described below relate to timing-based reports, it should be clear to one skilled in the art that the teaching is not limited to timing-based reports. Rather, the methods and techniques disclosed herein may be applied to any type of positioning related report such as, for example, received power measurements or angle measurements.

According to certain embodiments, two broad positioning scenarios are considered in the examples described below. In a first positioning scenario, which may be referred to as a network-based scenario, it is assumed that the positioning related reports are generated by a UE, a BS, or a TRP. These positioning related reports are reported to a centralized node in the network for determining the UE's position. For example, according to certain embodiments, the network configures the UE to transmit UL SRS and configures more than one TRP to receive the SRS signals. Each of the TRPs process the received signals to generate reports that can be used by the network to determine the UE position. As another example, according to certain embodiments, the UE receives DL PRS from a set of TRPs. The UE processes these received signals to generate reports that can be used by the network to determine the UE location.

In a second positioning scenario, which may be referred to as a UE-based scenario, the positioning related reports are generated by a UE. These positioning related reports are further utilized by the UE to determine its own location. For example, according to certain embodiments, the UE receives DL PRS from a set of TRPs. The UE processes these received signals to generate reports that can be further used by the UE to determine the UE's own location.

Current signal processing techniques are generally applied by the UE, BS, or TRP to generate positioning related reports in operating environments with LoS links. In certain embodiments described below, ToA is used as the main example. With the known speed of the radio wave, the ToA estimates can be converted to 3D distance estimates between the Transmit/Transmission/Transmitter (TX) and Receive/Reception/Receiver (RX) nodes. However, the methods, systems, and embodiments described herein are not limited to timing-based reports. Rather, the methods, systems and embodiments are applicable to any of the other positioning related reports such as, for example, received power measurements or angle measurements.

As used herein, the term “positioning generation entity” refers to the entity or node that is responsible for making the positioning calculation of the target UE. It may be noted that while the term “positioning related report” is used, it is intended to cover both the first case where the positioning related report generation entity is different from the positioning generation entity, and the second case where positioning related report generation entity is also the positioning generation entity.

For the first case, a positioning related report containing measurement is explicitly formulated and sent from a measurement entity to the positioning generation entity:
In network based-positioning cases, said position generation entity is normally residing in the LMF.
In a network-based positioning case, a positioning related report generation entity can a BS, or a TRP. For instance, the network can configure the UE to transmit UL SRS and configure more than one TRP to receive the SRS signals. Each of the TRPs processes the received signals to generate reports that can be used by the network to determine the UE position.
In a UE-assisted positing case, a positioning related report generation entity can be a UE. For instance, the UE receives DL PRS from a set of TRPs. The UE processes these received signals to generate reports that can be used by the network to determine the UE location.

For the second case, the positioning related report containing measurement does not need to be sent from one entity to another entity, and it is up to implementation how the concept of positioning related report is realized (either implicitly or explicitly):
In a UE-based position case, such positioning related reports are generated by a UE and further used by said UE to determine its own positions.

According to certain embodiments described herein, the multitude of positioning related reports provided to the positioning generation entity is referred to as the first set of positioning related reports.

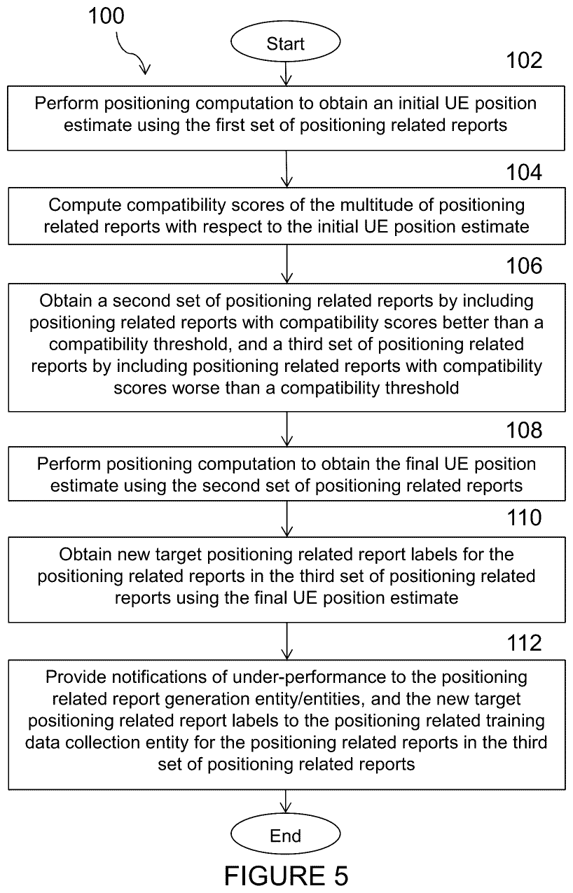

FIG. 5 illustrates an example method 100 performed by the position generation entity, according to certain embodiments. As depicted in FIG. 5, the position generation entity may perform may one or more of the following steps:
Step 102—Perform positioning computation to obtain an initial UE position estimate using a first set of positioning related reports.
Step 104—Compute compatibility scores of the multitude of positioning related reports with respect to the initial UE position estimate.
Step 106—Obtain a second set of positioning related reports by including positioning related reports with compatibility scores better than a compatibility threshold and a third set of positioning related reports by including positioning related reports with compatibility scores worse than a compatibility threshold. The second set of positioning related reports may partially or fully overlap with the first set of positioning related reports. The third set of positioning related reports may or may not be an empty set, and it does not overlap with the second set.
Step 108—Perform positioning computation to obtain the final UE position estimate using the second set of positioning related reports.
Step 110—Obtain new target positioning related report labels for the positioning related reports in the third set of positioning related reports using the final UE position estimate.
Step 112—Provide notifications of under-performance to the positioning related report generation entity/entities, and the new target positioning related report labels to the positioning related training data collection entity for the positioning related reports in the third set of positioning related reports.

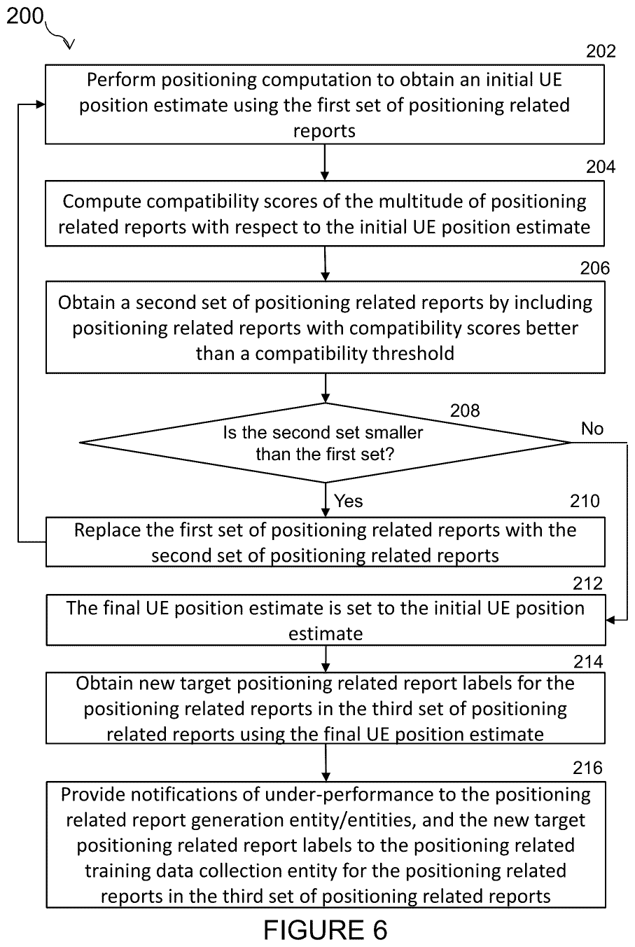

According to certain other embodiments, certain steps can be performed iteratively. FIG. 6 illustrates an example iterative method 200 performed by the position generation entity, according to certain embodiments. As depicted in FIG. 6, the position generation entity may perform the following steps:
Step 202—Perform positioning computation to obtain an initial UE position estimate using a first set of positioning related reports.
Step 204—Compute compatibility scores of the multitude of positioning related reports with respect to the initial UE position estimate.
Step 206—Obtain a second set of positioning related reports by including positioning related reports with compatibility scores better than a compatibility threshold and a third set of positioning related reports by including positioning related reports with compatibility scores worse than a compatibility threshold. The second set of positioning related reports may partially or fully overlap with the first set of positioning related reports. The third set of positioning related reports may or may not be an empty set, and it does not overlap with the second set.
Step 208—Determine whether the second set is smaller than the first set.
   If, at Step 208, it is determined that the second set of positioning related reports obtained in Step 206 is smaller than the first set of positioning related reports, the method proceeds to Step 210.
   Step 210—The first set of positioning related reports is replaced with the second set of positioning related reports. The method then returns to Steps 202 and 204. Specifically, the second set of positioning related reports are used to obtain, at Step 206, a modified third set of positioning related reports.
   However, if, at Step 208, it is determined that the second set of positioning related reports is not smaller than (or is the same as) the first set of positioning related reports, the method proceeds to Step 212.
Step 212—Set the final UE position estimate to the initial UE position estimate determined at Step 202.
Step 214—Obtain new target positioning related report labels for the positioning related reports in the third set of positioning related reports using the final UE position estimate.
Step 216—Provide notifications of under-performance to the positioning related report generation entity/entities, and provide the new target positioning related report labels to the positioning related training data collection entity for the positioning related reports in the third set of positioning related reports.

In a particular exemplary embodiment, the third set of positioning related reports is initialized as an empty set.

In a particular embodiment, the third set of positioning related reports is accumulated during the iterative process described above. For example, if the third set of positioning related reports already contains positioning related report #2 and #4 from the previous iteration and positioning related report #7 is identified as below compatibility threshold during the current iteration, then the third set of positioning related reports is updated to contain positioning related report #2, #4 and #7.

Herein, ToA is used as the main example. With the known speed of the radio wave, the ToA estimates can be equivalently converted to the 3D distance estimates between the TX and RX nodes. However, it should be clear to one skilled in the art that the methods and techniques described herein can be applied to any of the other positioning related reports.

Without losing generality, unless explicitly stated, ToA estimate is used as an example to represent various timing-based metrics, including: relative timing (e.g., UL RTOA), timing difference (e.g., DL RSTD), gNB Rx−Tx time difference, and UE Rx−Tx time difference. It is known that in real-life deployment, clocks are not accurately synchronized between TRP and UE, and/or between TRPs. Thus, ToA is often converted to other formats of timing metrics to combat the implementation imperfections. However, it should be clear to those skilled in the art that the same methods and techniques disclosed herein can be easily modified to apply to timing-based metrics in general.

The steps of FIGS. 5 and 6 are described in more detail below.

### Steps 102/202—Perform Positioning Computation to Obtain an Initial UE Position Estimate Using the First Set of Positioning Related Reports

The process of combining the positioning reports, e.g., ToAs, to locate the UE position using the distances (i.e., instead of angles) between nodes is called trilateration. The distances to at least three known non-collinear network nodes are sufficient to determine the exact 2D UE position.

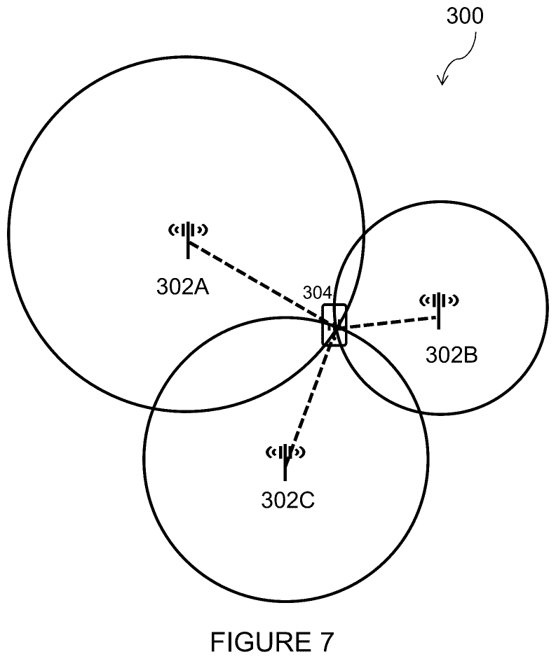

FIG. 7 illustrates an example 300 of ideal trilateration in a 2D space, according to certain embodiments. As shown in FIG. 7, if the positioning related reports are accurate, each TRP 302A, 302B, and 302C is at the center of a circle and the intersection of the circles pinpoints the location of the UE 304. In a 3D space, each TRP 302A, 302B, and 302C is at the center of a sphere, and at least four non-coplanar known network nodes' positions are needed to perform trilateration.

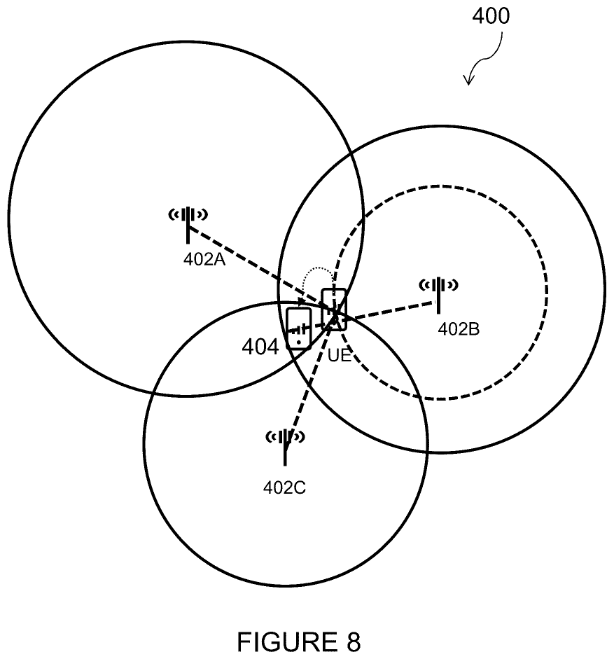

However, in real-world scenario, the estimated distances to the known positions can be inaccurate which result in faulty trilateration. FIG. 8 illustrates one such example 400 of trilateration with inaccurate positioning reports, according to certain embodiments. As shown in FIG. 8, each TRP 402A, 402B, and 402C is at the center of a respective circle. However, though the position of UE 404 would ideally be at the intersection, the actual position of UE 404 is slightly offset is not at the intersection of the circles.

A nonlimiting exemplary implementation of this positioning step is to find the UE position estimate that minimizes the sum of the loss between (a) the distance, d(\hat{p}_{UE}, p_{TRP}(i)), between the UE position estimate, \hat{p}_{UE}, and the known position of a TRP, p_{TRP}(i), and (b) the reported distance between the UE 404 and said TRP 402A, 402B, and 402C, \hat{d}(i):

$${\hat{p}}_{UE} = {arg min}_{{p}_{UE}} {\sum }_{i} ℒ ( d ( {p}_{UE} , {p}_{TRP} ( i ) ) , \hat{d} ( i ) )$$

where, [symbol] (·) can be L1 or L2 loss functions and i is the index of the positioning reports in the set.

L1 loss function, also known as Least Absolute Deviations (LAD), is the sum of the all the absolute differences between the true value, yᵢ, and the predicted value, ŷᵢ.

$$L 1 loss function {=}^{Δ} {\sum }_{i = 1}^{n} \vert {y}_{i} - {\hat{y}}_{i} \vert$$

L2 loss function, also known as Least Square Errors (LS), is the sum of the all the squared differences between the true value, yᵢ, and the predicted value, ŷᵢ.

$$L 2 loss function {=}^{Δ} {\sum }_{i = 1}^{n} {( {y}_{i} - {\hat{y}}_{i} )}^{2}$$

In another particular embodiment, a nonlimiting exemplary implementation of this positioning step is to compensate potential UE timing errors or jitters in the estimated ToA. This is achieved by adding a UE timing error related term to be jointly searched with hypothesized UE position:

$${\hat{p}}_{UE} , {\hat{δ}}_{UE} = {arg min}_{{p}_{UE} , {δ}_{UE}} {\sum }_{i} ℒ ( d ( {p}_{UE} , {p}_{TRP} ( i ) ) - {δ}_{UE} , \hat{d} ( i ) )$$

In still another particular embodiment, a nonlimiting exemplary implementation of this positioning step is to assume that the reported timing measurement is for TDoA instead of ToA, where TDoA(i, r) is obtained from measurements and c×TDoA(i, r) provides \hat{d}(i)−\hat{d}(r), where c is the speed of light. When using such TDoA, the TRPs are assumed to be synchronized. The benefit of TDoA is that clock offset (or clock drift) at the UE cancels out by measuring the difference of (a) ToA between TRP i and the UE, and (b) ToA between the reference TRP r and the UE, i≠r. Then the position of the UE can be estimated by considering the distance differences between (a) the UE positioning and a known TRP with index i and (b) the UE positioning and a reference TRP with index r.

$${\hat{p}}_{UE} = {arg min}_{{p}_{UE}} {\sum }_{i \neq r} ℒ ( d ( {p}_{UE} , {p}_{TRP} ( i ) ) - d ( {p}_{UE} , {p}_{TRP} ( r ) ) , \hat{d} ( i ) - \hat{d} ( r ) )$$

With the various types of loss functions provided above, an optimizer (or optimization algorithm, e.g., gradient descent) can be used to find the best UE position estimation that achieves the minimal value of the loss function. Note that neural network is typically not involved in this step, thus the loss functions above are not to be confused with the loss function used in the training of neural networks.

Steps 104/204—Compute Compatibility Scores of the Multitude of Positioning Related Reports with Respect to the Initial UE Position Estimate

The compatibility score of the positioning related reports is a function of the estimated UE position, \hat{p}_{UE}, and the deployment knowledge of the known network nodes. Thus, using the UE position estimate obtained in steps 102 and 202, the compatibility scores of positioning related reports are computed at steps 104 and 204, respectively.
in a particular embodiment, a nonlimiting example of said function is the square of the differences between (a) the distance, d(\hat{p}_{UE}, p_{TRP}(i)), between the UE position estimate, \hat{p}_{UE}, and the known position of a TRP, p_{TRP}(i), and (b) the reported distance between the UE and said TRP, \hat{d}(i):

CS(i) [symbol] |d(\hat{p}_{UE},p_{TRP}(i))−\hat{d}(i)|²

In another particular embodiment, a non-limiting example of said function is the absolute value of the differences between (a) the distance, d(\hat{p}_{UE}, p_{TRP}(i)), between the UE position estimate, \hat{p}_{UE}, and the known position of a TRP, p_{TRP}(i), and (b) the reported distance between the UE and said TRP, \hat{d}(i):

CS(i) [symbol] |d(\hat{p}_{UE},p_{TRP}(i))−\hat{d}(i)|

When the UE timing error estimate, \hat{δ}_{UE}, is available, yet another nonlimiting exemplary embodiment of said function is the square or the absolute value of the distance differences between (a) the distance, d(\hat{p}_{UE}, p_{TRP}(i)), between the UE position estimate, \hat{p}_{UE}, and the known position of a TRP, p_{TRP}(i), and (b) the sum of the reported distance between the UE and said TRP, \hat{d}(i), and the UE timing error related estimate:

CS(i) [symbol] |d(\hat{p}_{UE},p_{TRP}(i))−\hat{δ}_{UE}−\hat{d}(i)|²

or

CS(i) [symbol] |d(\hat{p}_{UE},p_{TRP}(i))−\hat{δ}_{UE}−\hat{d}(i)|

When the reported timing measurement is for TDoA instead of ToA, a further nonlimiting exemplary embodiment of said function is the square or the absolute value of the distance differences between (a) the UE positioning and a known TRP with index i and (b) the UE positioning and a reference TRP with index r:

CS(i) [symbol] |(d(\hat{p}_{UE},p_{TRP}(i))−d(\hat{p}_{UE},p_{TRP}(r)))−(\hat{d}(i)−\hat{d}(r))|²

or

CS(i) [symbol] |(d(\hat{p}_{UE},p_{TRP}(i))−d(\hat{p}_{UE},p_{TRP}(r)−(\hat{d}(i)−\hat{d}(r))|

Note, with the known speed of the radio wave, the ToA estimates can be equivalently converted to the 3D distance estimates between the TX and RX nodes. It should be clear to one skilled in the art that the compatibility scores can also be computed based on ToAs.

In yet another particular embodiment, a non-limiting example of said function includes computing the compatibility scores according to any of the above and ranking the compatibility scores from lowest values to highest values. The ranking order of a positioning related report is defined as the final compatibility score of said positioning related report.

With these nonlimiting exemplary compatibility scores, smaller compatibility scores indicate more compatibility with the UE position estimate \hat{p}_{UE}.

Steps 106/206—Obtain a Second Set of Positioning Related Reports by Including Positioning Related Reports with Compatibility Scores Better than a Compatibility Threshold, and Obtain a Third Set of Positioning Related Reports by Including Positioning Related Reports with Compatibility Scores Worse than a Compatibility Threshold

According to certain embodiments, in steps 106 and 206, the second set of positioning related reports is constructed by including the positioning related reports from the first set of positioning related reports that have compatibility scores better than a compatibility threshold.

For the nonlimiting exemplary embodiments of compatibility scoring functions provided in the above, a positioning related report is included in the second set of positioning related reports if its compatibility score, CS(i), is smaller than a threshold.

According to certain other embodiments, in steps 106 and 206, the second set of positioning related reports is constructed by taking the M positioning related reports that are most compatible with the UE position estimate \hat{p}_{UE}. As disclosed in steps 104 and 204, the compatibility threshold is the ranking of the compatibility scores.

In a further exemplary embodiment of steps 106 and 206, the second set of positioning related reports is constructed by excluding the N positioning related reports that are least compatible with the UE position estimate \hat{p}_{UE} from the first set of positioning related reports. As disclosed in steps 104 and 204, the compatibility threshold is the ranking of the compatibility scores.

In yet another exemplary embodiment of steps 106 and 206, the second set of positioning related reports is constructed by taking M′ positioning related reports that have the associated quality estimates (or confidence level, or reliability level) is better a certain threshold, while also satisfying the compatibility requirement. For timing related metrics, the quality of a timing value can be reported as the uncertainty of the timing value in units of meters. In this case, a timing value with better quality corresponds to smaller uncertainty values.

The positioning related reports from the first set of positioning related reports that have compatibility scores worse than a compatibility threshold are added to the third set of positioning related reports.

For the nonlimiting exemplary embodiments of compatibility scoring functions provided in the above, a positioning related report is added to the third set of positioning related reports if its compatibility score, CS(i), is larger than a threshold. In another exemplary embodiment of steps 106 and 206, the third set of positioning related reports is constructed by adding the N positioning related reports that are least compatible with the UE position estimate \hat{p}_{UE} from the first set of positioning related reports. In a further exemplary embodiment of steps 106 and 206, positioning related reports that are in the first set of positioning related reports but not in the second set of positioning related reports are added to the third set of positioning related reports.

The compatibility score threshold can be determined from the distribution of the compatibility scores.

The compatibility score threshold can be determined from the performance of the improved positioning algorithm disclosed herein with different compatibility score threshold.

The compatibility score threshold can be set to different values for different radio environments.

The compatibility score threshold can be set to different values for different iterations when certain steps of the main embodiment are executed iteratively.

The compatibility score threshold can be set to different values when the positioning related reports are provided by different approaches. For instance, the compatibility score threshold can be set to a different value when the positioning related reports are provided by advanced ML models than when the positioning related reports are provided by conventional signal processing algorithms.

The compatibility score threshold can be set to different values when the positioning related reports are provided by different advanced ML models. For instance, the compatibility score threshold can be set to a different value when the positioning related reports are provided by centralized ML models than when the positioning related reports are provided by distributed ML models.

### Steps 108 and a Final Performance of Step 202—Perform Positioning Computation to Obtain the Final UE Position Estimate Using the Second Set of Positioning Related Reports

The basic positioning computation method is the same as that used in step 102 and the initial performance of step 202 except that the second set of positioning related reports is used as the input at step 108 and a second iteration of step 202, respectively.

### Step 110 of FIG. 5/Step 214 of FIG. 6—Obtain New Target Positioning Related Report Labels for the Positioning Related Reports in the Third Set of Positioning Related Reports Using the Final UE Position Estimate

Suppose the positioning related report with index i is included in the third set of positioning related reports. Given the final UE position estimate \hat{p}_{UE}, a new target positioning related report is computed based on at least the distance between the final UE position estimate and the known position of the i-th TRP, \hat{p}_{TRP}(i), that receives or transmits at least one wireless signal for positioning:

d(\hat{p}_{UE},p_{TRP}(i))

As one nonlimiting example for a ML model generating target direct path ToAs, a new target label is computed as

$$t ( i ) {=}^{Δ} \frac{d ( {\hat{p}}_{UE} , {p}_{TRP} ( i ) )}{c}$$

where c is the speed of the wireless signal.

When the UE timing error related estimate, \hat{δ}_{UE}, is available, a new target label is computed as

$$t ( i ) {=}^{Δ} \frac{d ( {\hat{p}}_{UE} , {p}_{TRP} ( i ) ) - {\hat{δ}}_{UE}}{c}$$

Alternatively, if a ML model generates output for TDoA(s) between TRP i and TRP r, a new target label is computed as

$$t ( i ) {=}^{Δ} \frac{d ( {\hat{p}}_{UE} , {p}_{TRP} ( i ) ) - d ( {\hat{p}}_{UE} , {p}_{TRP} ( r ) )}{c}$$

where TRP r is the reference TRP.
Step 112 of FIG. 5/Step 216 of FIG. 6—Provide Notifications of Under-Performance to the Positioning Related Report Generation Entity/Entities, and the New Target Positioning Related Report Labels to the Positioning Related Training Data Collection Entity for the Positioning Related Reports in the Third Set of Positioning Related Reports

In a particular embodiment, the position generation entity can provide an all-clear signal to a positioning related report generation entity if no positioning related report generated by said positioning related report generation entity is included in the third set of positioning related reports.

In an alternative particular embodiment, the position generation entity does not provide signaling to a positioning related report generation entity if no positioning related report generated by said positioning related report generation entity is included in the third set of positioning related reports.

For this exemplary embodiment, a pre-defined time-out period is utilized by a positioning related report generation entity such that it can discard its received wireless signal and/or its pre-processed data.
Said pre-defined time-out period can be configured by the network to the position generation entity and/or the positioning related report generation entity.
Said pre-defined time-out period can be configured by the position generation entity to the positioning related report generation entity.
Said pre-defined time-out period can be stated in a system operation specifications.

### General Architecture

In general, the new target positioning related reports for those in the third set can be provided to improve subsequent report label estimation of the third set. The new target positioning related reports are sent from the position generation entity (Node B) to the positioning related training data collection entity (Node C), if Node C is different from Node B. Otherwise, (i.e., same node fulfills the functionality of Node B and Node C), the new target positioning related reports are directly stored by such node.

The training data collection entity may provide an updated training dataset in order to train (or re-train, or fine-tune) an updated AI/ML model for the positioning related report generation entity (Node A). The goal is that Node A can use the updated AI/ML model to generate more accurate report label estimation, thus improving the position estimation accuracy of the target UE.

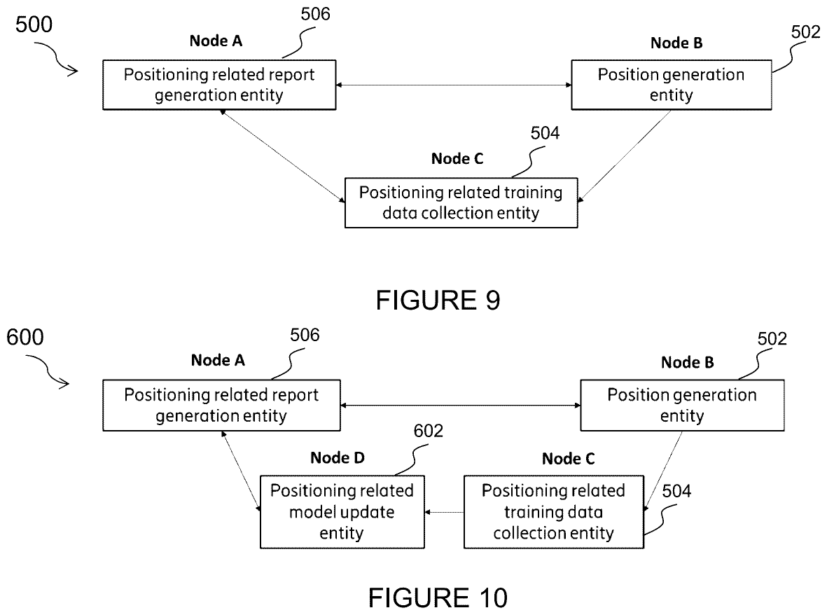

FIG. 9 illustrates an example high-level architecture 500 where the position generation entity (Node B) 502 provides positioning related labels to the positioning related training data collection entity (Node C) 504, according to certain embodiments. As illustrated, Node C 504 has model updating functionality and is able to provide an updated AI/ML model to Positioning related report generation entity (Node A) 506. Although the three entities are marked as Node A, Node B, and Node C in FIG. 9, it is recognized that two or more of the entities may be realized by a same functional node.

FIG. 10 illustrates another example high-level architecture 600, according to certain embodiments. Similar to FIG. 9, the architecture 600 includes a Node A 506, Node B 502, and Node C 504. However, in the depicted example, the model updating functionality is realized by a Node D 608, separate from the positioning related training data collection entity (Node C) 504, according to certain embodiments.

In the rest of the discussion, the simpler diagram of FIG. 9 is assumed for brevity, with the understanding that model updating functionality can be realized by a separate node as shown in FIG. 10.

The basic functions of the nodes of at least one particular embodiment are described below:
Node A 506 (Positioning related report generation entity) performs AI/ML model inference to generate positioning related report. Typically, the same Node A 506 also performs the function of measuring the wireless signal to obtain input data for model inference. Alternatively, a separate node (e.g., TRP, RP, gNB-DU) performs the function of measuring the wireless signal to obtain input data for model inference, and then send the obtained input data to Node A 508 (e.g., gNB-CU) to perform model inference.
Node B 502 (Position generation entity) is responsible for calculating the estimated location of the target UE.
Node C 504 (Positioning related training data collection entity) processes and stores information for constructing training dataset for the AI/ML model in Node A 506.
Node D 602 (Positioning related model update entity) uses the stored training dataset to train an updated AI/ML model, which can be used by Node A 506 to generate positioning related report. As described above, Node D 602 functionality can be embedded as a sub-function in Node C 504, or it can be fulfilled by a node separate from Node C 504.

Using the example of ToA as the measurement report sent from Node A 506 to Node B 502, when the new positioning related report labels (ToA) are generated by Node B 502 for the TRPs in the third set for the measurements performed at time T₁, the new labels Yⱼ(T₁) are sent to Node C for TRP-j together with the timestamp of T₁. Node C 504 also obtains channel measurements Xⱼ(T₁) associated with time T₁ from Node A 506. Together the {Xⱼ(T₁), Yⱼ(T₁)} pair makes a training data sample for TRP-j and the pair is stored by Node C 504.

When Node A 506 is a network node, the UL channel measurements Xⱼ(t) are made by a TRP based on the UL signal (e.g., SRS) sent by the target UE, and the measurement type correspond to that required as the input of the AI/ML model at Node A 506, for example, channel impulse response (CIR), or RSRP, or RSRPP. The AI/ML model may take as input the UL channel measurements Xⱼ(t) of a single TRP, or the AI/ML model may take as input multiple UL channel measurements Xⱼ(t) from multiple TRPs.

When Node A 506 is the UE, the DL channel measurements Xⱼ(t) are made by the UE based on the DL signal (e.g., PRS) sent by TRP(s), and the measurement type correspond to that required as the input of the AI/ML model at the UE, for example, channel impulse response (CIR), or RSRP, or RSRPP. The AI/ML model may take as input the DL channel measurements Xⱼ(t) of a single TRP, or the AI/ML model may take as input multiple DL channel measurements Xⱼ(t) corresponding to multiple TRPs.

In the following, various embodiments of the high-level architecture FIG. 9 are described in more detail below.

### Node a is gNB and Node B is Location Server (e.g., LMF)

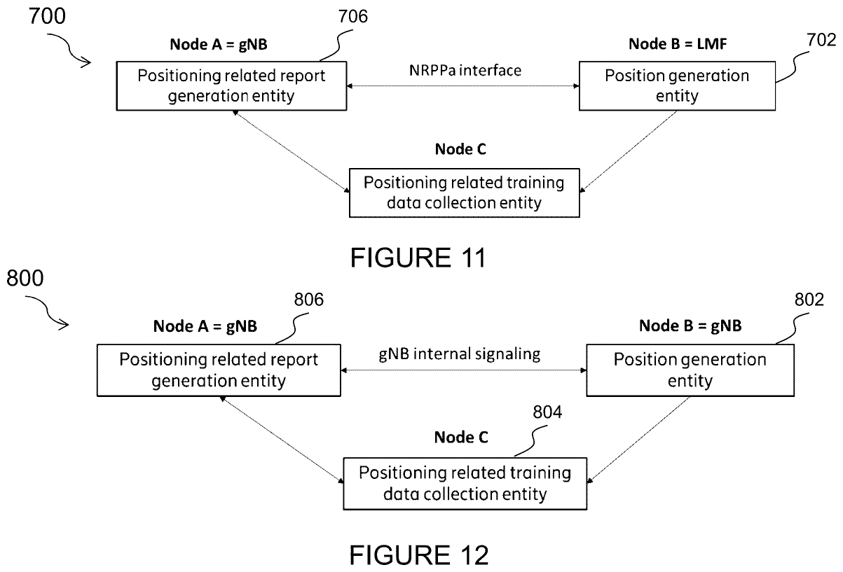

FIG. 11 illustrates an example architecture 700 where the location method is NG-RAN node assisted and LMF-based. Specifically, in FIG. 11, the NG-RAN node (i.e., gNB) act as the Node A 706 and provides positioning related report to the location server (e.g., LMF), which is Node B 702 in this example. The LMF acts to calculate the estimated UE location. For a given UE, the LMF may receive multiple positioning related reports associated with multiple TRPs. One or more gNB may send the positioning related reports to LMF via interface NRPPa.

### Node a is gNB and Node B is Also gNB

FIG. 12 illustrates an example architecture 800 of a single gNB acting as both the positioning related report generation entity (Node A) 806 to provide positioning related labels, as well as the position generation entity (Node B) 802. Additionally, or alternatively, a single gNB acts as both the position generation entity (Node B) 802 and the positioning related training data collection entity (Node C) 804.

This possible because a gNB can be connected to a multitude of TRPs. For Rel-17, a gNB can have a maximum of 65535 TRPs. Thus a single gNB can perform UL measurements of the UE from multiple TRPs, with a positioning related report generated for each TRP. With the multiple positioning related reports, the gNB is capable of calculating the UE location, thus fulfilling the functionality of Node B.

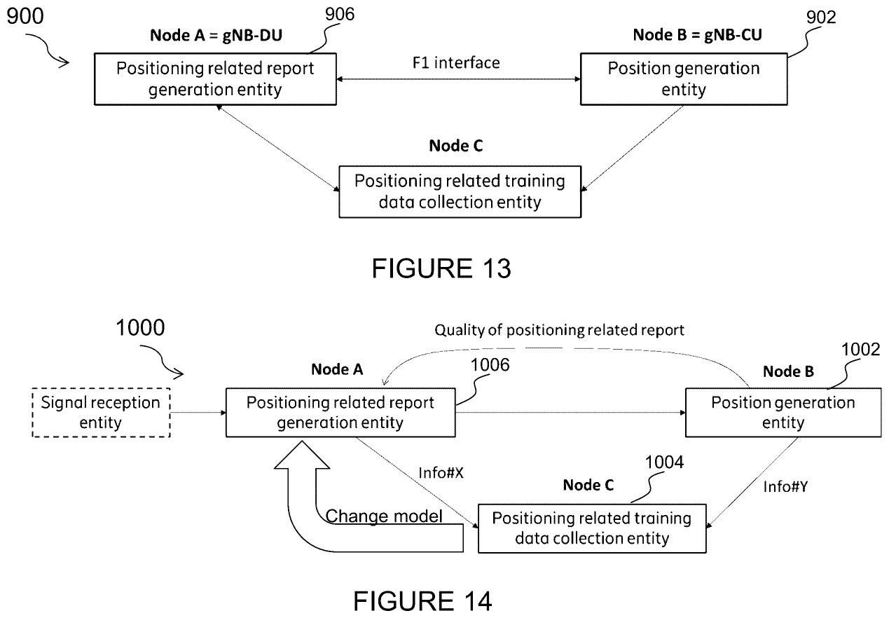

If a split architecture is used in the gNB, gNB-DU can act as Node A, while gNB-CU act as Node B. The positioning related report generated for multiple TRPs can be sent from gNB-DU to gNB-CU via the F1 interface. FIG. 13 illustrates a single gNB acts as both the Positioning related report generation entity (Node A) 906 and the Position generation entity (Node B) 902, where split architecture is used in the gNB.

In yet another embodiment, if TRPs of a gNB is equipped with baseband processing capability, then it is also possible that TRP(s) act as Node A to generate positioning related report, while other upper stream components of the gNB (e.g., gNB-DU or gNB-CU) act as Node B to determine the UE location.

### NG-RAN Acts as the Positioning Related Report Generation Entity

According to certain embodiments, a positioning related report generation entity performs the following steps to provide at least one positioning related report to a position generation entity and, when instructed by said position generation entity, compiles new training data based on already received wireless signal. In certain embodiments, the positioning related report generation entity (Node A) resides on the network side. Its function can be realized by various types of network node such as, for example a base station, a gNB, or a TRP, or a reception point (RP) including UL-SRS only RP:
Step 1—Receive at least one wireless signal on the uplink.
Step 2—Process said at least one received wireless signal to generate at least one positioning related report associated with at least one ML model.
Step 3—Signal said at least one positioning related report to a position generation entity.
Step 4—Receive signaling from said position generation entity.
   If no signaling is received from said position generation entity after a pre-defined period, discard said at least one received wireless signal or its pre-processed data.
Step 5—Compile new training data based on said received signaling from said position generation entity and forward said data to the positioning related training data collection entity.
   If the signaling from the position generation entity indicates under-performance of said at least one positioning related report with the corresponding at least one new target positioning related report label, combine said at least one received wireless signal or its pre-processed data with said at least one new target positioning related report label as at least one new training sample, and add said at least one new training sample to a training dataset.
   Otherwise, discard said at least one received wireless signal or its pre-processed data.

To provide further details of certain example embodiments, the ToA as the main example of the positioning related report. With the known speed of the radio wave, the ToA estimates can be equivalently converted to the distance estimates between the TX and RX nodes. However, it should be clear to one skilled in the art that the teaching can be applied to any of the other positioning related reports, for example, other timing-based reports, or received power based reports, or angle based reports.

In terms of other timing-based reports, the timing estimate can be represented in other formats, for instance, with the positioning related report generation entity (Node A) is a network side node,
A typical report is UL Relative Time of Arrival (T_{UL-RTOA}). The UL Relative Time of Arrival (T_{UL-RTOA}) is the beginning of subframe i containing SRS received in Reception Point (RP) j, relative to the RTOA Reference Time.
Another typical report is gNB Rx−Tx time difference. The gNB Rx−Tx time difference is defined as T_{gNB-RX}−T_{gNB-TX}. T_{gNB-RX} is the Transmission and Reception Point (TRP) received timing of uplink subframe #i containing SRS associated with UE, defined by the first detected path in time. T_{gNB-TX} is the TRP transmit timing of downlink subframe #j that is closest in time to the subframe #i received from the UE.

Additionally, while only one element (i.e., ToA) is used as a representative example to illustrate the methodology, it is understood that the positioning related report main contain multiple elements which are obtained from measurements of the UL wireless signal, for example, two or more of the following types:
Timing information of the received wireless signal, e.g., ToA of the UL wireless signal at the network node, UL TDoA, gNB Rx−Tx time difference.
Reference signal received power, e.g., UL SRS reference signal received power (UL SRS-RSRP)
Reference signal received path power, e.g., UL SRS reference signal received path power (UL SRS-RSRPP)
UL Angle of Arrival (AoA) (azimuth and/or elevation)
LoS/NLoS information
Quality estimation for one or more of the measurements above

### Step 1—Receive at Least One Wireless Signal on the Uplink.

A signal reception entity receives at least a UL wireless signal, which is used to generate at least a positioning related report in Step 2.

In a NG-RAN node assisted positioning case, a signal reception entity can be BS, or a gNB, or a TRP, or a reception point (RP). For instance, the network can configure the UE to transmit UL SRS and configure more than one TRP to receive the SRS signals. Each of the TRPs processes the received signals to generate reports that can be used by the network to determine the UE position.

The wireless signal on the uplink is typically an SRS. Moreover, the SRS can be a type specifically designed for positioning purposes, e.g., positioning SRS.

Step 2—Process Said at Least One Received Wireless Signal to Generate at Least One Positioning Related Report with at Least One ML Model.

A positioning related report generation entity (Node A) generates at least a positioning related report based on the received wireless signal, using a ML model. The positioning related report generation entity resides on the network side. It may or may not be realized by the same node as the signal reception entity, depending on the scope of functions fulfilled by a network node.
Examples of the same network node being the signal reception entity and the positioning related report generation entity: a base station, a gNB.
Examples of the different network nodes for the signal reception entity and the positioning related report generation entity:
   A TRP or a RP is the signal reception entity, gNB-DU is the positioning related report generation entity.

Using the NG-RAN node assisted positioning case as a nonlimiting example, a TRP receives the SRS transmitted from a UE on different frequencies as

R[k]=H[k]·S[k]+N[k]

where
S[k] is the SRS on frequency index k
H[k] is the frequency domain channel response on frequency index k
N[k] denotes the noise and/or interference on frequency index k

A ML model may take the received signals at multiple frequencies, R[k], and the corresponding SRS signals, S[k], as inputs and generates a ToA estimate as output.

However, for a modern wideband communication system, the size of the number inputs for such a model may become very large and cost high computational complexity in the ML models. Alternatively, the ML model may be constructed to take pre-processed data as input instead.

As a nonlimiting example, the frequency domain channel response (FD CR) can be estimated from the received SRS signals at different frequencies:

Ĥ[k] [symbol] S*[k]·R[k]

where S*[k] denotes the complex conjugate of the SRS signal S[k]. The time domain channel impulse response (TD CIR) can be estimated by passing the frequency domain channel response through an inverse fast Fourier transform (FFT), resulting in a series of ĥ[n] with n as the time domain tap index. Since wireless signal strength attenuates with travelled distances, the time domain channel impulse response normally has meaningful responses only for a limited number of taps. That is, the time domain channel impulse response can be truncated to a shorter length. Such a truncated time domain channel impulse response estimate is a nonlimiting example of the pre-processed data of the at least one received wireless signal.

Using such properly designed pre-processed data as input, a ML model can achieve similar or better performance with lower computational complexity than a ML model that takes the at least one received wireless signal directly as input.

### Step 3—Signal Said at Least One Positioning Related Report to a Position Generation Entity.

The at least one positioning related report generated by Node A can be signaled to a position generation entity (Node B) using existing system protocols or procedures.

The positioning related report mainly carry the measurement results of the UL wireless signal, e.g., ToA estimation generated by the ML model. In addition, other auxiliary information may be carried as part of the report as well. Such auxiliary information is not directly the measurement results, but provides the context information of the measurement. The auxiliary information may include the following information of the measurement result: time stamp, cell ID, TRP ID, ARP (Antenna Reference Point) ID, antenna beam information, information of the received SRS (including SRS resource ID, SRS configuration), etc.

When sending the at least one positioning related report from the positioning related report generation entity (Node A) to the position generation entity (Node B), the report may traverse one or more other intermediate network nodes in-between.

In one embodiment, the report is encapsulated and sent as is from Node A to Node B without any change by intermediate node (if any).

Alternatively, the report may be repackaged by an intermediate node when going from Node A to Node B. For example, if gNB uses a split architecture and Node A is realized by one or more gNB-DU, then the positioning related report(s) generated by the one or more gNB-DU is sent to gNB-CU (i.e., an intermediate node) via F1 interface. The gNB-CU then collect the positioning related report(s) in a measurement report according to the message format of NRPPa interface. Afterwards, the measurement report is sent from gNB-CU to LMF via the NRPPa interface, where LMF is position generation entity (Node B).

Step 4—Receive Signaling from Said Position Generation Entity.

As described above, the position generation entity (Node B) receives the at least one positioning related report from the positioning related report generation entity (Node A), and attempts to determine the location of the target UE using the positioning related report(s). Related to the step of determining the location of the target UE, the position generation entity (Node B) can additionally determine the quality of the positioning related report(s), and generate signaling on the quality. The quality signaling can be sent to the positioning related report generation entity (Node A), and/or a training data collection entity (Node C), and/or a model monitoring entity. The training data collection entity (Node C) is preferably a network-side server.

The signaling can take two values on the report quality:
Signaled value=“poor quality report”. If a positioning related report is determined to have unacceptably large estimation error, then the position generation entity (Node B) can mark it as “poor quality report”, and send such signaling to other nodes. Such quality estimation is an indication that the ML model needs improvement, where the model had been used to generate the at least one positioning related report in Node A.
   When signaled value=“poor quality report”, Node B can further generate a new target positioning related report label for the associated report, and send the new label to Node C.
Signaled value=“good quality report”. If the signaling from the position generation entity indicates “good quality report”, this implies that the positioning related report has small estimation error and the ML model in Node A functions properly.

While the signaling is a judgement on quality of a given positioning related report, such signalling can be collected and observed continuously by a model monitoring entity, so as to determine whether and when to trigger a model update. In a preferred embodiment, a moving monitoring window of duration Tₘ is defined. When the number of signalling indicating poor quality (“poor quality report”) in the moving window is above a threshold, then the model monitoring entity may trigger an action to change the associated ML model. The action taken may be one or more of the following:
a) deactivation, i.e., the existing ML model should be stopped from generating positioning related report. After deactivation, a fall-back method (e.g., a conventional, non-AI/ML method) can be used to determine UE location instead.
b) model update, i.e., the existing ML model should be updated so that a new, improved, model can be used for future generation of positioning related report. The new model can be obtained by retraining or fine-tuning the model with a new dataset, or obtained via model delivery from another entity.

In addition to the signaling to Node C, signaling need to be sent from Node B to Node A as well. The purpose of signaling to Node A is to retrieve the received wireless signal (and/or its pre-processed data) associated with “poor quality report” from Node A. The retrieved signal and/or data correspond to ML model input, and is then sent from Node A to Node C.

If no signaling is received from said position generation entity (Node B) after a pre-defined time-out period, the positioning related report generation entity (Node A) can discard said at least one received wireless signal and/or its pre-processed data.
Said pre-defined time-out period can be configured by the network to the position generation entity and/or the positioning related report generation entity.
Said pre-defined time-out period can be configured by the position generation entity to the positioning related report generation entity.
Said pre-defined time-out period can be stated in a system operation specifications.
   Step 5—Compile New Training Data Based on Said Received Signaling from Said Position Generation Entity and Forward Said Data to the Positioning Related Training Data Collection Entity.

If the signaling from the position generation entity (Node B) indicates under-performance (i.e., “poor quality report”) of said at least one positioning related report, and provides the corresponding at least one new target positioning related report label, then a positioning related training data collection entity (Node C) can combine Info #X (i.e., said at least one received wireless signal and/or its pre-processed data) with Info #Y (i.e., said at least one new target positioning related report label) as at least one new training sample, and add said at least one new training sample to a training dataset. Node C (training data collection entity) obtains Info #X from Node A (positioning related report generation entity), while Node C obtains Info #Y from Node B (position generation entity).

Using the simplified example of ToA as the measurement report sent from Node A to Node B, the procedure is explained in the following in more concrete terms. When the new positioning related report labels (ToA) are generated by Node B for the TRP-j for the measurements performed at time T₁, the new labels Yⱼ(T₁) are Info #Y, and are sent to Node C, together with the auxiliary information of {time stamp of T₁, TRP-j}. Using this auxiliary information, Node C also obtains channel measurements Xⱼ(T₁) from Node A, where Xⱼ(T₁) is the measurements of the wireless signal (and/or its pre-processed data) at time T₁ and TRP-j. Together the {Xⱼ(T₁), Yⱼ(T₁)} pair makes a training data sample for TRP-j and the pair is stored by Node C.

The new target positioning related report label need to be accompanied by the auxiliary information carried in the positioning related report, so that the new label (Info #Y) can be matched to the corresponding sample of Info #X (wireless signal reception or its pre-processed data), for example, the measured wireless signal with the correct time stamp, TRP ID, and SRS configuration.

If the signaling from the position generation entity indicates “good quality report” of said at least one positioning related report, this implies that the positioning related report has small estimation error and the ML model in Node A functions properly. Hence the positioning related training data collection entity (Node C) may not add any new training sample to the training dataset from the corresponding received wireless signal and/or its pre-processed data.

FIG. 14 illustrates and/or relates to Step 1-Step 5 as described above. Specifically, FIG. 14 illustrates an example architecture 1000 where position generation entity (Node B) provides quality feedback on positioning related report to positioning related report generation entity (Node A) 1006. For a report determined to be “poor quality report”, Node B 1002 generates and sends Info #Y to Positioning related training data collection entity (Node C), while Node A 1006 sends the corresponding Info #X to Node C 1004. Node C 1004 pairs up {Info #X, Info #Y} to build a new training sample and add it to the training dataset. After model updating, a new ML model can be provided to Node A 1006.

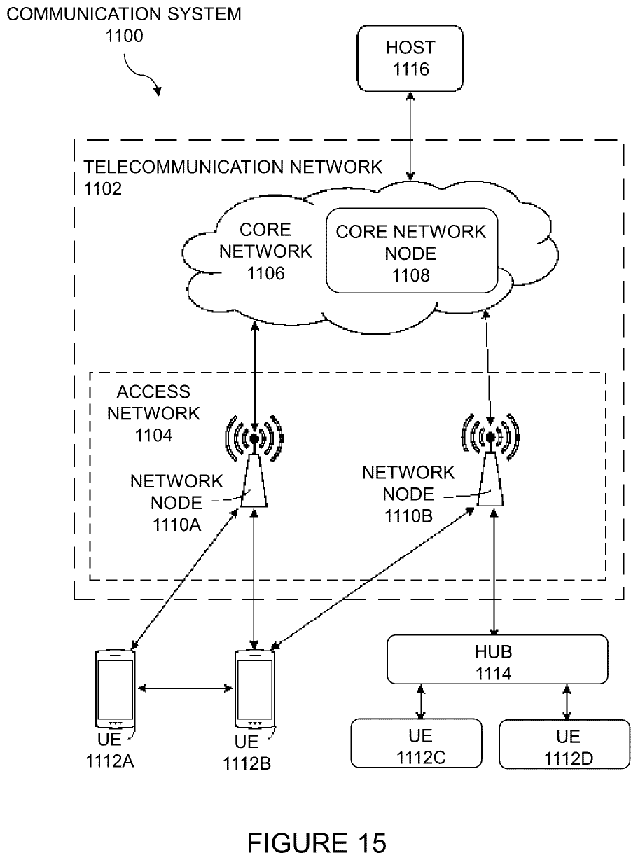

FIG. 15 shows an example of a communication system 1100 in accordance with some embodiments. In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3^{rd} Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

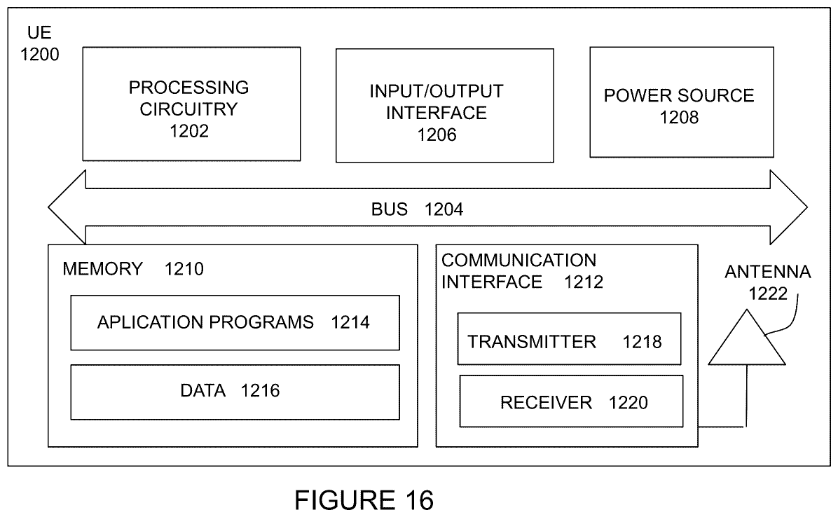

FIG. 16 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

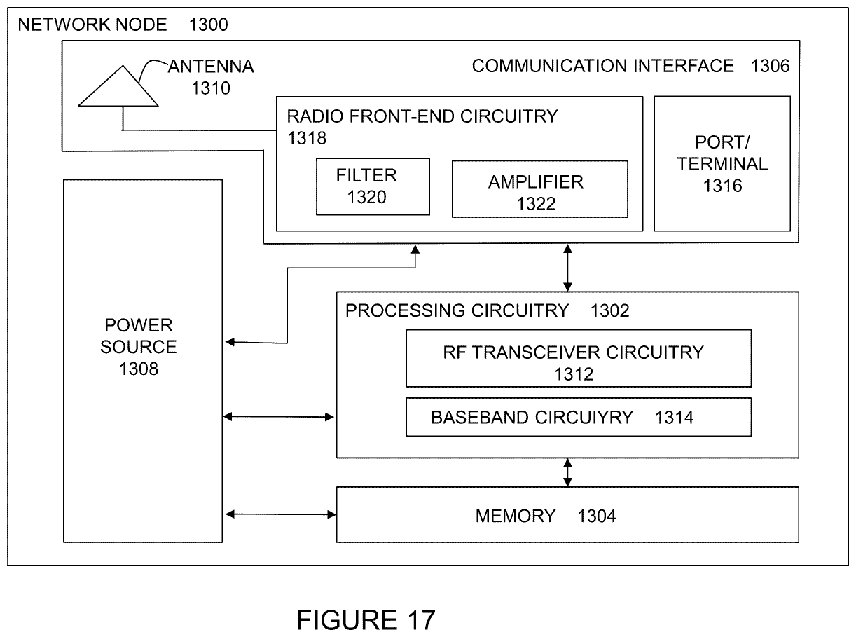

FIG. 17 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 17 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

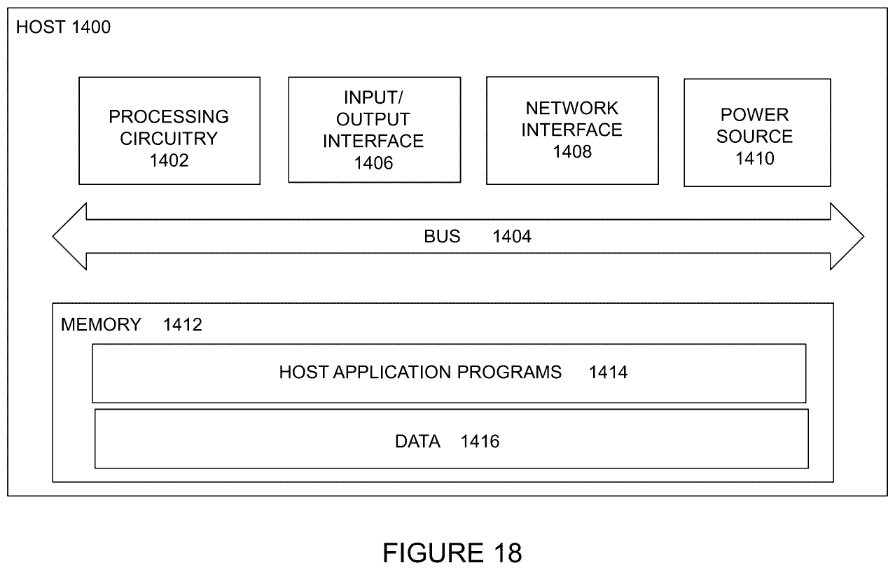

FIG. 18 is a block diagram of a host 1400, which may be an embodiment of the host 1116 of FIG. 15, in accordance with various aspects described herein.

As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

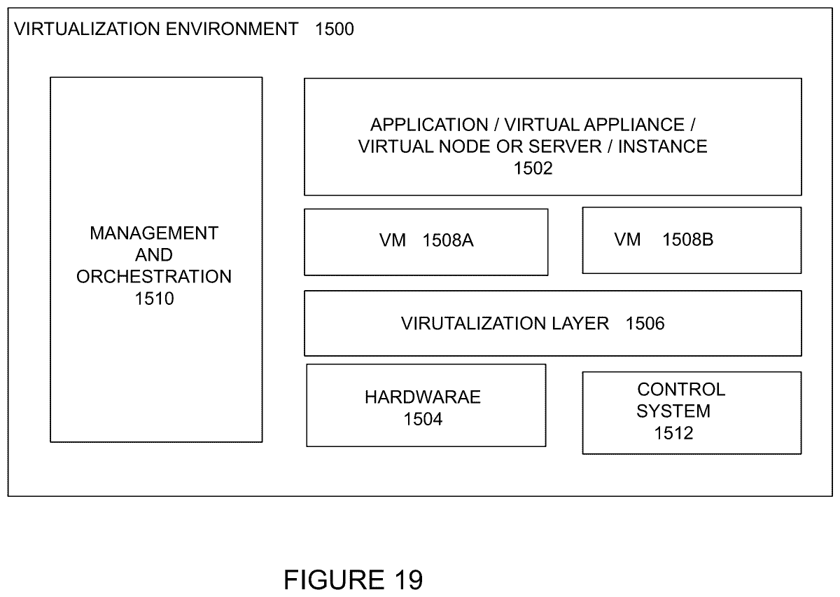

FIG. 19 is a block diagram illustrating a virtualization environment 1500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

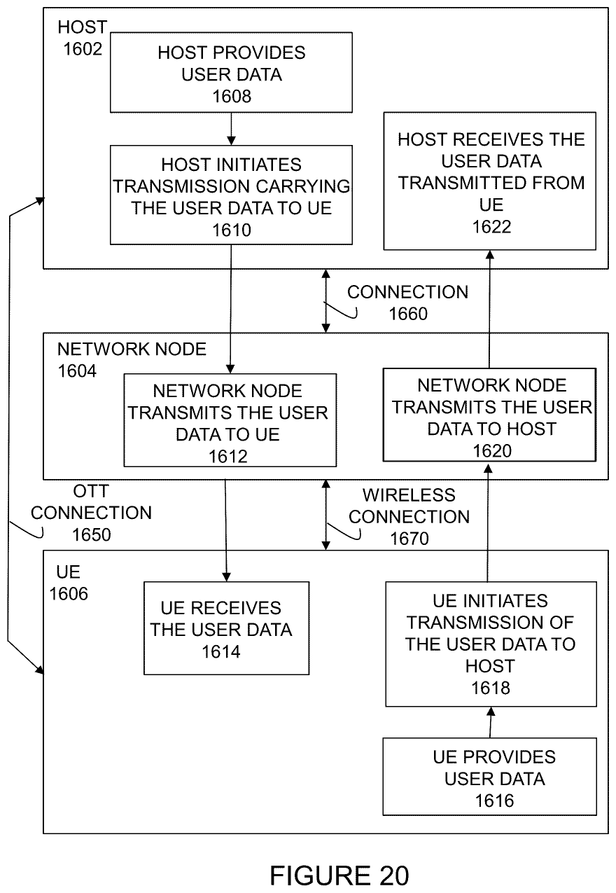

FIG. 20 shows a communication diagram of a host 1602 communicating via a network node 1604 with a UE 1606 over a partially wireless connection in accordance with some embodiments.

Example implementations, in accordance with various embodiments, of the UE (such as a UE 1112a of FIG. 15 and/or UE 1200 of FIG. 16), network node (such as network node 1110a of FIG. 15 and/or network node 1300 of FIG. 17), and host (such as host 1116 of FIG. 15 and/or host 1400 of FIG. 17) discussed in the preceding paragraphs will now be described with reference to FIG. 20.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 15) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

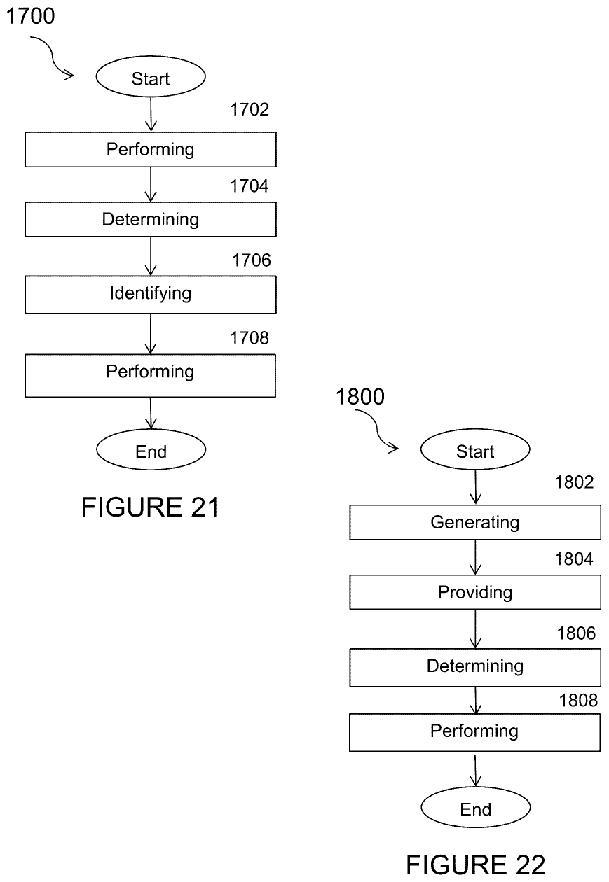

FIG. 21 illustrates an example method 1700 by a UE 1112 or network node 1110 for improved UE positioning, according to certain embodiments. In the illustrated embodiment, the method includes a performing step at 1702, a determining step at 1704, an identifying step at 1706, and a performing step at 1708.

For example, in a UE implemented method, the method may begin at step 1702 when, based on a first set of positioning related reports, the UE 1112 performs positioning computation to obtain a first UE position estimate. At step 1704, the UE 1112 may determine a compatibility score for each positioning related report in the first set of positioning related reports. Based on the compatibility scores for each positioning related report in the first set of positioning related reports, the UE 1112 may identify a second set of positioning related reports and a third set of positioning reports, at step 1706. Based on the second set of positioning related reports, the UE 1112 may perform positioning computation to obtain a second UE position estimate.

As another example, in a network node-implemented method, the method may begin at step 1702 when, based on a first set of positioning related reports, the network node 1110 performs positioning computation to obtain a first UE position estimate. At step 17004, the network node 1110 may determine a compatibility score for each positioning related report in the first set of positioning related reports. Based on the compatibility scores for each positioning related report in the first set of positioning related reports, the network node 1110 may identify a second set of positioning related reports and a third set of positioning reports, at step 1706. Based on the second set of positioning related reports, the network node 1110 may perform positioning computation to obtain a second UE position estimate.

FIG. 22 illustrates another method 1800 by a network node 1112 for improved UE positioning, according to certain embodiments. In the illustrated embodiment, the method includes a generating step at 1804, a providing step at 1806, a determining step at 1808, and a performing step 1810. For example, based on the at least one wireless signal received on an uplink channel from a UE, the network node 1112 generates at least one positioning related report associated with at least one ML model, at step 1804. At step 1806, the network node 1112 provides the at least on positioning related report to a position generation entity. At step 1808, the network node 112 determines whether feedback is received from the position generation entity. At step 1810, the network node 1112 performs at least one operation based on whether the feedback is received from the position generation entity.

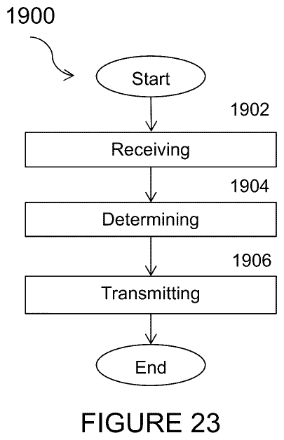

FIG. 23 illustrates another example method 1900 by a network node 1112 operating as a position generating entity for improved UE-assisted positioning, according to certain embodiments. In the illustrated embodiment, the method includes a receiving step at 1902, a determining step at 1904, and a transmitting step at 1906. For example, at step 1902, the network node 1112 may receive, from a network node operating as a position related report generation entity, at least one positioning related report generated based on at least one downlink wireless signal Based on the at least one positioning related report, the network node 1112 may determine a location of a UE, at step 1904. At step 1906, the network node 1112 may transmit feedback to the network node operating as the position related report generation entity, and the feedback indicates at least one of: the location of the UE 1110 and a quality of the at least one positioning related report.

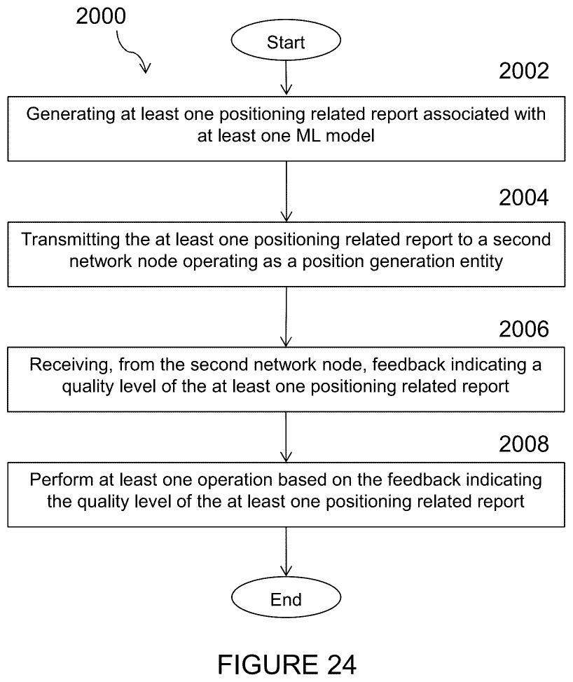

FIG. 24 illustrates a method 2000 by a first network node 1110 for improved UE positioning, according to certain embodiments. As illustrated, the method includes generating at least one positioning related report associated with at least one ML model, at step 2002. At step 2004, the network node 1110 transmits the at least one positioning related report to a second network node 1110 operating as a position generation entity. At step 2006, the network node 1110 receives, from the second network node, feedback indicating a quality level of the at least one positioning related report. At step 2008, the network node 1110 performs at least one operation based on the feedback indicating the quality level of the at least one positioning related report.

In a particular embodiment, when the feedback is not received from the position generation entity within a time period, performing the at least one operation includes discarding data associated with at least one wireless signal received on the uplink channel.

In a particular embodiment, performing the at least one operation includes at least one of: generating or compiling new training data based on the feedback received from the position generation entity; and transmitting the new training data to a positioning related training data collection entity.

In a particular embodiment, the feedback comprises an indication of a good quality of the at least one positioning related report, and performing the at least one action includes: based on the indication of the good quality of the at least one positioning related report, continuing to use the at least one model for determining a location of a UE 1112 and/or generation of positioning related reports.

In a particular embodiment, the feedback indicates a poor quality of the at least one positioning related report, and performing the at least one operation includes generating at least one new training sample based on at least one of: the at least one wireless signal received on the uplink, data associated with the at least one wireless signal, and at least one target positioning related report label. The network node 1110 adds the at least one new training sample to a training data set.

In a particular embodiment, performing the at least one operation includes: based on the poor quality of the at least one positioning related report, deactivating the at least one ML model used for determining a location of the UE and/or generation of the at least one positioning related report.

In a further particular embodiment, performing the at least one operation includes: based on the poor quality of the at least one positioning related report, updating the at least one ML model used for determining a location of the UE and/or generation of the at least one positioning related report.

In a particular embodiment, generating the at least one positioning related report includes receiving, from the UE, at least one value associated with at least one measurement performed by the UE based on the wireless signal. The at least one positioning related report comprises the at least one value associated with the at least one performed measurement.

In a further particular embodiment, the at least one value comprises at least one of: an UL SRS-RSRP value; an UL SRS-RSRPP value; a ToA estimation or value; an TDoA, value; an UL AoA; a gNB Rx−Tx time difference value; and a reception time value.

In a particular embodiment, the at least one positioning related report includes a UE location estimation; a time stamp associated with at least one measurement and/or at least one value; a Cell ID; a TRP ID; SSB information; spatial direction information; DL-PRS configuration information; LoS information; NLoS information; and a quality estimation value associated with at least one measurement performed on the wireless signal received on the uplink channel.

In a particular embodiment, providing the at least one positioning related report to the position generation entity includes transmitting the at least one positioning related report to a second network node operating as a LMF.

In a particular embodiment, the network node 1110 inputs the at least one wireless signal into the at least one ML model and receiving a location estimate of the UE from the at least one ML model.

In a particular embodiment, the network node 1110 performs pre-processing to convert the at least one wireless signal into an input for the at least one ML model. The network node 1110 inputs the converted input into the at least one ML model and receives a location estimate of the UE from the at least one ML model.

In a particular embodiment, the at least one location estimate comprises at least one ToA estimate.

In a particular embodiment, the at least one wireless signal comprises at least one SRS.

In a particular embodiment, the first network node comprises: a base station: a gNodeB; a TRP; or a reception point.

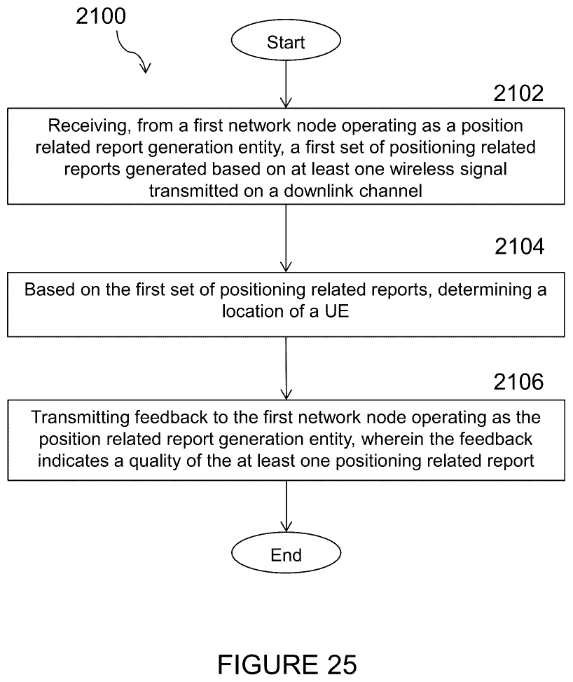

FIG. 25 illustrates a method 2100 by a second network node 1110 operating as a position generating entity for improved assisted positioning, according to certain embodiments. In the illustrated embodiment, the method begins at step 2102 when the second network node 1110 receives, from a first network node 1110 operating as a position related report generation entity, a first set of positioning related reports generated based on at least one wireless signal transmitted on a downlink channel. Based on the first set of positioning related reports, the second network node 1110 determines a location of a UE 1112, at step 2104. At step 2106, the second network node 1110 transmits feedback to the first network node operating as the position related report generation entity. The feedback indicates a quality of the at least one positioning related report.

In a particular embodiment, when determining the location of the UE, the second network node 1110 performs positioning computation to obtain a first UE position estimate based on the first set of positioning related reports. Based on a respective compatibility scores for each positioning related report in the first set of positioning related reports, the second network node 1110 identifies a second set of positioning related reports having compatibility scores that are better than a compatibility threshold and a third set of positioning related reports having compatibility scores that are not better than the compatibility threshold. The second network node 1110 transmits, to the first network node, a notification that the third set of positioning reports is associated with compatibility scores that are not better than the compatibility threshold.

In a particular embodiment, the second set of positioning related reports is a first subset of the first set of positioning related reports, and the third set of positioning related reports is a subset of the first set of positioning related reports.

In a particular embodiment, based on a distance between the location of the UE and a known position of a TRP, the second network node 1110 obtains at least one new target positioning related report label for at least one positioning related report in the third set of positioning related reports. The second network node 1110 transmits the at least one new target positioning related report label to the first network node 1110.

In a particular embodiment, when obtaining the at least one new target positioning related report label for the at least one positioning related report in the third set of positioning related reports, the second network node 1110 computes the at least one new target positioning related report label based on at least one of: a speed of the wireless signal; a UE timing error related estimate; and a Time Difference of Arrival between two TRPs.

In a particular embodiment, the second network node 1110 compares the location of the UE as determined by the second network node to an estimated location of the UE provided in the first set of positioning related reports. The second network node 1110 determines the quality of the first set of positioning related reports based on the comparing of the location of the UE as determined by the second network node to the estimated location of the UE provided in the first set of positioning related reports.

In a further particular embodiment, when the estimated location of the UE provided in the first set of positioning related reports is less than or equal to a threshold distance from the location of the UE as determined by the second network node, the feedback comprises an indication of a good quality of the at least one positioning related report.

In a particular embodiment, when the estimated location of the UE provided in the first set of positioning related reports is more than a threshold distance from the location of the UE as determined by the second network node, the feedback comprises an indication of a poor quality of the at least one positioning related report.

In a particular embodiment, the first set of positioning related reports comprises at least one value associated with at least one measurement performed by the UE based on the at least one wireless signal. The at least one value comprises at least one of: a DL RSTD value; a DL PRS-RSRP value; a DL PRS-RSRPP value; a ToA estimation or value; a UE Rx−Tx, time difference value; and a transmit time value.

In a particular embodiment, the first set of positioning related reports includes: a UE location estimation; a time stamp associated with at least one measurement and/or at least one value; a Cell ID; a TRP ID; SSB information; spatial direction information; DL-PRS configuration information; LoS information; NLoS information; and a quality estimation value associated with at least one measurement performed on the wireless signal received on the downlink channel.

In a particular embodiment, the at least one location estimate comprises at least one ToA estimate.

In a particular embodiment, the at least one wireless signal includes at least one PRS associated with at least one TRP.

In a particular embodiment, the second network node operating as a position generating entity is a LMF.

In a particular embodiment, the first network node operating as the position related report generation entity is a gNodeB or a TRP.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method by a user equipment (UE) for improved UE positioning, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for improved UE positioning, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a UE for improved UE positioning, the method comprising: based on a first set of positioning related reports, performing positioning computation to obtain a first UE position estimate (step 1); determining a compatibility score for each positioning related report in the first set of positioning related reports (step 2); based on the compatibility scores for each positioning related report in the first set of positioning related reports, identifying (step 3): a second set of positioning related reports, and a third set of positioning related reports; and based on the second set of positioning related reports, performing positioning computation to obtain a second UE position estimate (step 4).

Example Embodiment C2. The method of Example Embodiment C1, wherein the second set of positioning related reports partially overlaps with the first set of positioning related reports.

Example Embodiment C3. The method of Example Embodiment C1, wherein the second set of positioning related reports fully overlaps with the first set of positioning related reports.

Example Embodiment C4. The method of any one of Example Embodiments C1 to C3, wherein the third set of positioning related reports does not overlap with the second set of positioning related reports.

Example Embodiment C5. The method of any one of Example Embodiments C1 to C3, wherein the third set of positioning related reports is an empty set.

Example Embodiment C5b. The method of Example Embodiment C5, comprising transmitting, to a network node or another UE operating as a positioning related report generation entity, at least one of: an all-clear signal; an indication that the third set of positioning related reports is an empty set; an indication that none of the positioning related reports in the first set of positioning related reports has under-performed; and an indication that none of the positioning related reports in the first set of positioning related reports has a compatibility score below a threshold.

Example Embodiment C6. The method of any one of Example Embodiments C1 to C5b, wherein identifying the second set of positioning related reports based on the compatibility scores comprises: for each positioning related report in the first set of positioning related reports, comparing an associated compatibility score to a compatibility threshold, and selecting any positioning related reports that have a compatibility score that is greater than (or greater than or equal to) the compatibility threshold.

Example Embodiment C7. The method of Example Embodiment C6, wherein the second compatibility threshold is determined based on at least one of: a distribution of the compatibility scores for the first set of positioning related reports; a radio environment; a performance of a positioning algorithm; a type of model or algorithm used to generate the first set of positioning related reports; and a number of iterations used to obtain a final UE position estimate.

Example Embodiment C8. The method of any one of Example Embodiments C1 to C5, wherein identifying the second set of positioning related reports based on the compatibility scores comprises: based on each respective compatibility score, determining a ranking for each positioning related report in the first set of positioning related reports, wherein the ranking for each positioning related report indicates a level compatibility of the positioning related report with the first UE position estimate.

Example Embodiment C9. The method of Example Embodiment C8, comprising: based on the ranking, selecting a number, N, of positioning related reports from the first set of positioning related reports that are least compatible with the first UE position estimate; and excluding the N positioning related reports that are least compatible from the second set of positioning related reports.

Example Embodiment C10. The method of Example Embodiment C8, comprising: based on the ranking, selecting a number, M, of positioning related reports from the first set of positioning related reports that are most compatible with the first UE position estimate; and including the M positioning related reports that are most compatible in the second set of positioning related reports.

Example Embodiment C11. The method of any one of Example Embodiments C9 to C10, wherein N and/or M are determined based on at least one of: a setting and/or performance and/or type of a model or algorithm used to generate the first set of positioning related reports; and a radio environment.

Example Embodiment C12. The method of any one of Example Embodiments C6 to C11, comprising: determining a quality level of each one of the first set of positioning related reports or the second set of positioning related reports; comparing the quality level of each one of the first set of positioning related reports or the second set of positioning related reports to a quality threshold; and removing any positioning related reports that have a quality level below the quality threshold from the second set of positioning related reports and/or adding any positioning related reports that have a quality level above the quality threshold to the third set of positioning related reports.

Example Embodiment C13. The method of any one of Example Embodiments C1 to C5, wherein identifying the second set of positioning related reports and the third set of positioning related reports comprises: for each positioning related report in the first set of positioning related reports, comparing an associated compatibility score to a compatibility threshold, and performing one of: selecting any positioning related reports that have a compatibility score that is more than or equal to the first compatibility threshold for the second set of positioning related reports and selecting any positioning related reports that have a compatibility score that is less than the first compatibility threshold for the third set of positioning related reports; selecting any positioning related reports that have a compatibility score that is more than the first compatibility threshold for the second set of positioning related reports and selecting any positioning related reports that have a compatibility score that is less than or equal to the first compatibility threshold for the third set of positioning related reports.

Example Embodiment C14. The method of Example Embodiment C13, wherein the compatibility threshold is determined based on at least one of: a distribution of the compatibility scores for the first set of positioning related reports; a radio environment; a performance of a positioning algorithm; a type of model or algorithm used to generate the first set of positioning related reports; and a number of iterations used to obtain a final UE position estimate.

Example Embodiment C15. The method of any one of Example Embodiments C1 to C5, wherein identifying the second set of positioning related reports and the third set of positioning related reports comprises: based on each respective compatibility score, determining a ranking for each positioning related report in the first set of positioning related reports, wherein the ranking for each positioning related report indicates a level compatibility of the positioning related report with the first UE position estimate; and performing at least one of: based on the ranking, selecting a number, N, of positioning related reports from the first set of positioning related reports that are least compatible with the first UE position estimate and including the N positioning related reports that are least compatible from the second set of positioning related reports in the third set of positioning related reports; and based on the ranking, selecting a number, M, of positioning related reports from the first set of positioning related reports that are most compatible with the first UE position estimate and including the M positioning related reports that are most compatible with the first UE position estimate in the second set of positioning related reports.

Example Embodiment C16. The method of Example Embodiment C15, wherein N and/or M are determined based on at least one of: a setting and/or performance and/or type of a model or algorithm used to generate the first set of positioning related reports; and a radio environment.

Example Embodiment C17. The method of any of one of Example Embodiments C1 to C16, comprising outputting the second UE position estimate.

Example Embodiment C18. The method of any one of Example Embodiments C1 to C16, comprising: determining that the second set of positioning related reports is smaller than the first set of positioning related reports; and based on the second set of positioning related reports being smaller than the first set of positioning related reports, outputting the second UE position estimate.

Example Embodiment C19. The method of any one of Example Embodiments C1 to C16, comprising: determining that the second set of positioning related reports is less than a minimum number of positioning related reports; and based on the second set of positioning related reports being less than the minimum number of positioning related reports, outputting the first UE position estimate.

Example Embodiment C20. The method of Example Embodiment C19, comprising determining the minimum number of positioning related reports based on a type of the first set of positioning related reports.

Example Embodiment C21. The method of Example Embodiment C20, wherein the type of the first set of positioning related reports is associated with 2D positioning or 3D positioning.

Example Embodiment C22. The method of any one of Example Embodiments C1 to C16, comprising: determining that the second set of positioning related reports is not smaller than the first set of positioning related reports; and based on the second set of positioning related reports not being smaller than the first set of positioning related reports, replacing the first set of positioning related reports with the second set of positioning related reports; and repeating steps 1-4 until a final set of positioning related reports is smaller than a preceding set of positioning related reports; and outputting a final UE position estimate based on positioning computation performed on the final set of positioning related reports.

Example Embodiment C23. The method of any one of Example Embodiments C1 to C22, comprising: based on a distance between the second UE position estimate or the final UE position estimate and a known position of a TRP, obtaining at least one new target positioning related report label for at least one positioning related report in the third set of positioning related reports; and transmitting, the at least one new target positioning related report label to a network node or another UE operating as a positioning related training data collection entity.

Example Embodiment C24. The method of any one of Example Embodiments C1 to C22, comprising: based on a distance between the second UE position estimate or the final UE position estimate and a known position of a TRP, generating at least one new or updated positioning related report for at least one positioning related report in the third set of positioning related reports; and transmitting, the at least one new or updated positioning related report to a network node or another UE operating as a positioning related training data collection entity.

Example Embodiment C25. The method of any one of Example Embodiments C1 to C24, comprising transmitting, to a network node or another UE operating as a positioning related report generation entity, at least one of: an indication at least one of the positioning related reports in the first set of positioning related reports has under-performed; and an indication that at least one of the positioning related reports in the first set of positioning related reports has a compatibility score below a threshold.

Example Embodiment C26. The method of any one of Example Embodiments C1 to C25, wherein performing positioning computation to obtain the first UE position estimate and/or the second UE position estimate comprises using trilateration.

Example Embodiment C27. The method of any one of Example Embodiment C1 to C26, wherein performing positioning computation to obtain the first UE position estimate and/or the second UE position estimate is based on at least one of: one or more ToAs; one or more TDoAs; one or more loss functions; and one or more estimated timing errors and/or jitters.

Example Embodiment C28. The method of any one of Example Embodiments C1 to C27, wherein the compatibility score for each positioning related report in the first set of positioning related reports is determined as a function of the first UE position estimate and a known position of at least one network node.

Example Embodiment C29. The method of any one of Example Embodiments C1 to C28 comprising transmitting, the second UE position estimate and/or a final UE position estimate to a network node.

Example Embodiment C30. The method of any one of Example Embodiments C1 to C29, wherein the first set of positioning related reports comprises at least one value associated with at least one NLoS between the UE and at least one TRP.

Example Embodiment C31. The method of any one of Example Embodiments C1 to C30, wherein the first set of positioning related reports comprises at least one value associated with at least one LoS between the UE and at least one TRP.

Example Embodiment C32. The method of any one of Example Embodiments C1 to C31, further comprising: providing user data; and forwarding the user data to a host via the transmission to the network node.

Example Embodiment C33. A user equipment comprising processing circuitry configured to perform any of the methods of Example Embodiments C1 to C32.

Example Embodiment C34. A user equipment configured to or adapted to perform any of the methods of Example Embodiments C1 to C32.

Example Embodiment C35. A wireless device comprising processing circuitry configured to perform any of the methods of Example Embodiments C1 to C32.

Example Embodiment C36. A computer program comprising instructions which when executed on a computer perform any of the methods of Example Embodiments C1 to C32.

Example Embodiment C37. A computer program product comprising computer program, the computer program comprising instructions which when executed on a computer perform any of the methods of Example Embodiments C1 to C32.

Example Embodiment C38. A non-transitory computer readable medium storing instructions which when executed by a computer perform any of the methods of Example Embodiments C1 to C32.

### Group D Example Embodiments

Example Embodiment D1. A method by a network node for improved UE positioning, the method comprising: based on a first set of positioning related reports, performing positioning computation to obtain a first UE position estimate (step 1); determining a compatibility score for each positioning related report in the first set of positioning related reports (step 2); based on the compatibility scores for each positioning related report in the first set of positioning related reports, identifying (step 3): a second set of positioning related reports, and a third set of positioning related reports; and based on the second set of positioning related reports, performing positioning computation to obtain a second UE position estimate (step 4).

Example Embodiment D2. The method of Example Embodiment D1, comprising obtaining the first set of positioning related reports from a plurality of other network nodes.

Example Embodiment D3. The method of Example Embodiment D2, wherein the plurality of other network nodes comprise at least one base station and/or at least one TRP.

Example Embodiment D4. The method of Example Embodiment D1, comprising obtaining the first set of positioning related reports from a UE.

Example Embodiment D5. The method of any one of Example Embodiments D1 to D4, wherein the second set of positioning related reports partially overlaps with the first set of positioning related reports.

Example Embodiment D6. The method of any one of Example Embodiments D1 to D4, wherein the second set of positioning related reports fully overlaps with the first set of positioning related reports.

Example Embodiment D7. The method of any one of Example Embodiments D1 to D6, wherein the third set of positioning related reports does not overlap with the second set of positioning related reports.

Example Embodiment D8. The method of any one of Example Embodiments D1 to D6, wherein the third set of positioning related reports is an empty set.

Example Embodiment D9. The method of Example Embodiment D8, comprising transmitting, to a network node or another UE operating as a positioning related report generation entity, at least one of: an all-clear signal; an indication that the third set of positioning related reports is an empty set; an indication that none of the positioning related reports in the first set of positioning related reports has under-performed; and an indication that none of the positioning related reports in the first set of positioning related reports has a compatibility score below a threshold.

Example Embodiment D10. The method of any one of Example Embodiments D1 to D9, wherein identifying the second set of positioning related reports based on the compatibility scores comprises: for each positioning related report in the first set of positioning related reports, comparing an associated compatibility score to a compatibility threshold, and selecting any positioning related reports that have a compatibility score that is greater than (or greater than or equal to) the compatibility threshold.

Example Embodiment D11. The method of Example Embodiment D10, wherein the second compatibility threshold is determined based on at least one of: a distribution of the compatibility scores for the first set of positioning related reports; a radio environment; a performance of a positioning algorithm; a type of model or algorithm used to generate the first set of positioning related reports; and a number of iterations used to obtain a final UE position estimate.

Example Embodiment D12. The method of any one of Example Embodiments D1 to D9, wherein identifying the second set of positioning related reports based on the compatibility scores comprises: based on each respective compatibility score, determining a ranking for each positioning related report in the first set of positioning related reports, wherein the ranking for each positioning related report indicates a level compatibility of the positioning related report with the first UE position estimate.

Example Embodiment D13. The method of Example Embodiment D12, comprising: based on the ranking, selecting a number, N, of positioning related reports from the first set of positioning related reports that are least compatible with the first UE position estimate; and excluding the N positioning related reports that are least compatible from the second set of positioning related reports.

Example Embodiment D14. The method of Example Embodiment D12, comprising: based on the ranking, selecting a number, M, of positioning related reports from the first set of positioning related reports that are most compatible with the first UE position estimate; and including the M positioning related reports that are most compatible in the second set of positioning related reports.

Example Embodiment D15. The method of any one of Example Embodiments D13 to D14, wherein N and/or M are determined based on at least one of: a setting and/or performance and/or type of a model or algorithm used to generate the first set of positioning related reports; and a radio environment.

Example Embodiment D16. The method of any one of Example Embodiments D10 to D15, comprising: determining a quality level of each one of the first set of positioning related reports or the second set of positioning related reports; comparing the quality level of each one of the first set of positioning related reports or the second set of positioning related reports to a quality threshold; and removing any positioning related reports that have a quality level below the quality threshold from the second set of positioning related reports and/or adding any positioning related reports that have a quality level above the quality threshold to the third set of positioning related reports.

Example Embodiment D17. The method of any one of Example Embodiments D1 to D9, wherein identifying the second set of positioning related reports and the third set of positioning related reports comprises: for each positioning related report in the first set of positioning related reports, comparing an associated compatibility score to a compatibility threshold, and performing one of: selecting any positioning related reports that have a compatibility score that is more than or equal to the first compatibility threshold for the second set of positioning related reports and selecting any positioning related reports that have a compatibility score that is less than the first compatibility threshold for the third set of positioning related reports; selecting any positioning related reports that have a compatibility score that is more than the first compatibility threshold for the second set of positioning related reports and selecting any positioning related reports that have a compatibility score that is less than or equal to the first compatibility threshold for the third set of positioning related reports.

Example Embodiment D18. The method of Example Embodiment D17, wherein the compatibility threshold is determined based on at least one of: a distribution of the compatibility scores for the first set of positioning related reports; a radio environment; a performance of a positioning algorithm; a type of model or algorithm used to generate the first set of positioning related reports; and a number of iterations used to obtain a final UE position estimate.

Example Embodiment D19. The method of any one of Example Embodiments D1 to D9, wherein identifying the second set of positioning related reports and the third set of positioning related reports comprises: based on each respective compatibility score, determining a ranking for each positioning related report in the first set of positioning related reports, wherein the ranking for each positioning related report indicates a level compatibility of the positioning related report with the first UE position estimate; and performing at least one of: based on the ranking, selecting a number, N, of positioning related reports from the first set of positioning related reports that are least compatible with the first UE position estimate and including the N positioning related reports that are least compatible from the second set of positioning related reports in the third set of positioning related reports; and based on the ranking, selecting a number, M, of positioning related reports from the first set of positioning related reports that are most compatible with the first UE position estimate and including the M positioning related reports that are most compatible with the first UE position estimate in the second set of positioning related reports.

Example Embodiment D20. The method of Example Embodiment D19, wherein N and/or M are determined based on at least one of: a setting and/or performance and/or type of a model or algorithm used to generate the first set of positioning related reports; and a radio environment.

Example Embodiment D21. The method of any of one of Example Embodiments D1 to D20, comprising outputting the second UE position estimate.

Example Embodiment D22. The method of any one of Example Embodiments D1 to D20, comprising: determining that the second set of positioning related reports is smaller than the first set of positioning related reports; and based on the second set of positioning related reports being smaller than the first set of positioning related reports, outputting the second UE position estimate.

Example Embodiment D23. The method of any one of Example Embodiments D1 to D20, comprising: determining that the second set of positioning related reports is less than a minimum number of positioning related reports; and based on the second set of positioning related reports being less than the minimum number of positioning related reports, outputting the first UE position estimate.

Example Embodiment D24. The method of Example Embodiment D23, comprising determining the minimum number of positioning related reports based on a type of the first set of positioning related reports.

Example Embodiment D25. The method of Example Embodiment D24, wherein the type of the first set of positioning related reports is associated with 2D positioning or 3D positioning.

Example Embodiment D26. The method of any one of Example Embodiments D1 to D20, comprising: determining that the second set of positioning related reports is not smaller than the first set of positioning related reports; and based on the second set of positioning related reports not being smaller than the first set of positioning related reports, replacing the first set of positioning related reports with the second set of positioning related reports; and repeating steps 1-4 until a final set of positioning related reports is smaller than a preceding set of positioning related reports; and outputting a final UE position estimate based on positioning computation performed on the final set of positioning related reports.

Example Embodiment D27. The method of any one of Example Embodiments D1 to D26, comprising: based on a distance between the second UE position estimate or the final UE position estimate and a known position of a TRP, obtaining at least one new target positioning related report label for at least one positioning related report in the third set of positioning related reports; and transmitting, the at least one new target positioning related report label to a network node or another UE operating as a positioning related training data collection entity.

Example Embodiment D28. The method of any one of Example Embodiments D1 to D26, comprising: based on a distance between the second UE position estimate or the final UE position estimate and a known position of a TRP, generating at least one new or updated positioning related report for at least one positioning related report in the third set of positioning related reports; and transmitting, the at least one new or updated positioning related report to a network node or another UE operating as a positioning related training data collection entity.

Example Embodiment D29. The method of any one of Example Embodiments D1 to D28, comprising transmitting, to a network node or another UE operating as a positioning related report generation entity, at least one of: an indication at least one of the positioning related reports in the first set of positioning related reports has under-performed; and an indication that at least one of the positioning related reports in the first set of positioning related reports has a compatibility score below a threshold.

Example Embodiment D30. The method of any one of Example Embodiments D1 to D29, wherein performing positioning computation to obtain the first UE position estimate and/or the second UE position estimate comprises using trilateration.

Example Embodiment D31. The method of any one of Example Embodiment D1 to D30, wherein performing positioning computation to obtain the first UE position estimate and/or the second UE position estimate is based on at least one of: one or more ToAs; one or more TDoAs; one or more loss functions; and one or more estimated timing errors and/or jitters.

Example Embodiment D32. The method of any one of Example Embodiments D1 to D31, wherein the compatibility score for each positioning related report in the first set of positioning related reports is determined as a function of the first UE position estimate and a known position of at least one network node.

Example Embodiment D33. The method of any one of Example Embodiments D1 to D32, comprising transmitting, the second UE position estimate and/or a final UE position estimate to another network node.

Example Embodiment D34. The method of any one of Example Embodiments D1 to D33, comprising transmitting, the second UE position estimate and/or a final UE position estimate to the UE.

Example Embodiment D35. The method of any one of Example Embodiments D1 to D34, wherein the first set of positioning related reports comprises at least one value associated with at least one NLoS between the UE and at least one TRP.

Example Embodiment D36. The method of any one of Example Embodiments D1 to D35, wherein the first set of positioning related reports comprises at least one value associated with at least one LoS between the UE and at least one TRP.

Example Embodiment D37. The method of any one of Example Embodiments D1 to D36, wherein the network node is operating as a LMF.

Example Embodiment D38. The method of any of Example Embodiments D1 to D37, further comprising: obtaining user data; and forwarding the user data to a host or a user equipment.

Example Embodiment D39. A network node comprising processing circuitry configured to perform any of the methods of Example Embodiments D1 to D38.

Example Embodiment D40. A network node configured to perform any of the methods of Example Embodiments D1 to D38.

Example Embodiment D41. A computer program comprising instructions which when executed on a computer perform any of the methods of Example Embodiments D1 to D38.

Example Embodiment D42. A computer program product comprising computer program, the computer program comprising instructions which when executed on a computer perform any of the methods of Example Embodiments D1 to D38.

Example Embodiment D43. A non-transitory computer readable medium storing instructions which when executed by a computer perform any of the methods of Example Embodiments D1 to D38.

### Group E Example Embodiments

Example Embodiment E1. A method by a network node for improved UE positioning, the method comprising: based on the at least one wireless signal received on an uplink channel from a UE, generating at least one positioning related report associated with at least one ML model; providing the at least on positioning related report to a position generation entity; determining whether feedback is received from the position generation entity; and performing at least one operation based on whether the feedback is received from the position generation entity.

Example Embodiment E2. The method of Example Embodiment E1, wherein, when the feedback is not received from the position generation entity within a time period, performing the at least one operation comprises at least one of: discarding the at least one wireless signal received on the uplink channel; and discarding data associated with at least one wireless signal received on the uplink channel.

Example Embodiment E3. The method of Example Embodiment E1, wherein, when the feedback is received from the position generation entity, performing the at least one operation comprises at least one of: generating or compiling new training data based on the feedback received from the position generation entity; and transmitting the new training data to a positioning related training data collection entity.

Example Embodiment E4. The method Example Embodiment E3, wherein the feedback comprises an indication of a good quality of the at least one positioning related report.

Example Embodiment E5. The method Example Embodiment E4, comprising: based on the good quality of the at least one positioning related report, continuing to use a ML model for determining a location of the UE and/or generation of positioning related reports.

Example Embodiment E6. The method of Example Embodiment E3, wherein, when the feedback indicates under-performance of at least one positioning related report, performing the at least one operation comprises: combining the at least one wireless signal received on the uplink and/or pre-processed data associated with the at least one wireless signal and/or at least one target positioning related report label to generate at least one new training sample; and adding the at least one new training sample to a training data set.

Example Embodiment E7. The method Example Embodiment E6, wherein the feedback comprises an indication of a poor quality of the at least one positioning related report.

Example Embodiment E8. The method Example Embodiment E7, comprising: based on the poor quality of the at least one positioning related report, deactivating a ML model used for determining a location of the UE and/or generation of positioning related reports.

Example Embodiment E9. The method Example Embodiment E7, comprising: based on the poor quality of the at least one positioning related report, updating a ML model used for determining a location of the UE and/or generation of positioning related reports.

Example Embodiment E10. The method of any one of Example Embodiments E1 to E9, wherein generating the at least one positioning related report based on the at least one wireless signal comprises: performing at least one measurement based on the wireless signal received on the uplink channel, and wherein the at least one positioning related report comprises at least one value associated with the at least one performed measurement.

Example Embodiment E11. The method of any one of Example Embodiments E1 to E10, wherein the at least one value comprises at least one of: a UL RSTD value; a UL SRS-RSRP value; a UL SRS-RSRPP value; a ToA estimation or value; an UL TDoA value; UL Angle of Arrival; a gNB Rx−Tx time difference value; and a reception time value.

Example Embodiment E12. The method of any one of Example Embodiments E1 to E11, wherein the at least one positioning related report comprises: a UE location estimation; a time stamp associated with at least one measurement and/or at least one value; a cell ID; a TRP ID; SSB information; spatial direction information; UL-SRS configuration information; LoS information; NLoS information; and a quality estimation value associated with at least one measurement performed on the wireless signal received on the uplink channel.

Example Embodiment E13. The method of any one of Example Embodiments E1 to E12, wherein providing the at least one positioning related report to the position generation entity comprises transmitting the at least one positioning related report to a second network node operating as a LMF.

Example Embodiment E14. The method of any one of Example Embodiments E1 to E12, wherein the position generation entity is located in the network node, and wherein the position generation entity operates to determine a location of the UE based on the at least one positioning related report.

Example Embodiment E15. The method of any one of Example Embodiments E1 to E14, wherein the feedback is received from the position generation entity, and wherein the feedback comprises a location of the UE as determined based on the at least one positioning related report.

Example Embodiment E16. The method of any one of Example Embodiments E1 to E15, comprising inputting the at least one wireless signal into a ML model and receiving a location estimate of the UE from the ML model.

Example Embodiment E17. The method of any one of Example Embodiments E1 to E15, comprising performing pre-processing to convert the at least one wireless signal received on the uplink channel into an input for a ML model and inputting the converted input into the ML model and receiving a location estimate of the UE from the ML model.

Example Embodiment E18. The method of any one of Example Embodiments E16 to E17, wherein the at least one location estimate comprises at least one ToA estimate.

Example Embodiment E19. The method of any one of Example Embodiments E1 to E18, wherein the at least one wireless signal comprises at least one SRS.

Example Embodiment E20. The method of any one of Example Embodiments E1 to E19, wherein the at least one wireless signal comprises a plurality of SRS, wherein each SRS is associated with a respective one of a plurality of TRPs.

Example Embodiment E21. The method of any one of Example Embodiments E1 to E20, wherein the network node comprises a base station, a gNB, a TRP, or a reception point.

Example Embodiment E22. The method of any one of Example Embodiments E1 to E21, further comprising: providing user data; and forwarding the user data to a host via the transmission to the network node.

Example Embodiment E23. A user equipment comprising processing circuitry configured to perform any of the methods of Example Embodiments E1 to E22.

Example Embodiment E24. A user equipment configured to or adapted to perform any of the methods of Example Embodiments E1 to E22.

Example Embodiment E25. A wireless device comprising processing circuitry configured to perform any of the methods of Example Embodiments E1 to E22.

Example Embodiment E26. A computer program comprising instructions which when executed on a computer perform any of the methods of Example Embodiments E1 to E22.

Example Embodiment E27. A computer program product comprising computer program, the computer program comprising instructions which when executed on a computer perform any of the methods of Example Embodiments E1 to E22.

Example Embodiment E28. A non-transitory computer readable medium storing instructions which when executed by a computer perform any of the methods of Example Embodiments E1 to E23.

### Group F Example Embodiments

Example Embodiment F1. A method by a network node operating as a position generating entity for improved UE-assisted positioning, the method comprising: receiving, from a network node operating as a position related report generation entity, at least one positioning related report generated based on at least one downlink wireless signal; based on the at least one positioning related report, determining a location of a UE; and transmitting feedback to the network node operating as the position related report generation entity, wherein the feedback indicates at least one of: the location of the UE and a quality of the at least one positioning related report.

Example Embodiment F2. The method of Example Embodiment F1, comprising: comparing the determined location of the UE to an estimated location of the UE provided in the at least one positioning related report; and determining the quality of the at least one positioning related report based on the comparing step.

Example Embodiment F3. The method Example Embodiment F2, wherein, when the estimated location of the UE is less than or equal to a threshold distance from determined location of the UE, the feedback comprises an indication of a good quality of the at least one positioning related report.

Example Embodiment F4. The method Example Embodiment F2, wherein, when the estimated location of the UE is more than a threshold distance from determined location of the UE, the feedback comprises an indication of a poor quality of the at least one positioning related report.

Example Embodiment F5. The method of any one of Example Embodiments F1 to F4, wherein the at least one value comprises at least one of: a DL RSTD value; a DL PRS-RSRP value; a DL PRS-RSRPP value; a ToA estimation or value; a UE Rx−Tx time difference value; and a transmit time value.

Example Embodiment F6. The method of any one of Example Embodiments F1 to F5, wherein the at least one positioning related report comprises: a UE location estimation; a time stamp associated with at least one measurement and/or at least one value; a cell ID; a TRP ID; SSB information; spatial direction information; DL-PRS configuration information; LoS information; NLoS information; and a quality estimation value associated with at least one measurement performed on the wireless signal received on the downlink channel.

Example Embodiment F7. The method of any one of Example Embodiments F1 to F6, wherein the at least one location estimate comprises at least one ToA estimate.

Example Embodiment F8. The method of any one of Example Embodiments F1 to F7, wherein the at least one wireless signal comprises at least one PRS associated with at least one TRP.

Example Embodiment F9. The method of any one of Example Embodiments F1 to F8, wherein the at least one wireless signal comprises a plurality of PRS, wherein each PRS is associated with a respective one of a plurality of TRPs.

Example Embodiment F10. The method of any one of Example Embodiments F1 to F9, wherein the network node operating as a position generating entity is an LMF.

Example Embodiment F11. The method of any one of Example Embodiments F1 to F10, wherein the network node operating as the position related report generation entity is a gNB or a TRP.

Example Embodiment F12. The method of any of Example Embodiments F1 to F11, further comprising: obtaining user data; and forwarding the user data to a host or a user equipment.

Example Embodiment F13. A network node comprising processing circuitry configured to perform any of the methods of Example Embodiments F1 to F12.

Example Embodiment F14. A network node configured to perform any of the methods of Example Embodiments F1 to F12.

Example Embodiment F15. A computer program comprising instructions which when executed on a computer perform any of the methods of Example Embodiments F1 to F12.

Example Embodiment F16. A computer program product comprising computer program, the computer program comprising instructions which when executed on a computer perform any of the methods of Example Embodiments F1 to F12.

Example Embodiment F17. A non-transitory computer readable medium storing instructions which when executed by a computer perform any of the methods of Example Embodiments F1 to F12.

### Group G Example Embodiments

Example Embodiment G1. A user equipment (UE) for improved UE positioning, the UE comprising: processing circuitry configured to perform any of the steps of any of the Group A and C Example Embodiments; and power supply circuitry configured to supply power to the processing circuitry.

Example Embodiment G2. A network node for improved UE positioning, the network node comprising: processing circuitry configured to perform any of the steps of any of the Group B, D, E, and F Example Embodiments; power supply circuitry configured to supply power to the processing circuitry.

Example Embodiment G3. A user equipment (UE) for improved UE positioning, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment G4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein:
the processing circuitry of the host is configured to execute a host application, thereby providing the user data; and the host application is configured to interact with a client application executing on the UE, the client application being associated with the host application.

Example Embodiment G7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment G8. The method of the previous Example Embodiment, further comprising: at the host, executing a host application associated with a client application executing on the UE to receive the user data from the UE.

Example Embodiment G9. The method of the previous Example Embodiment, further comprising: at the host, transmitting input data to the client application executing on the UE, the input data being provided by executing the host application, wherein the user data is provided by the client application in response to the input data from the host application.

Example Emboidment G10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment G11. The host of the previous Example Embodiment, wherein the cellular network further includes a network node configured to communicate with the UE to transmit the user data from the UE to the host.

Example Embodiment G12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment G14. The method of the previous Example Embodiment, further comprising: at the host, executing a host application associated with a client application executing on the UE to receive the user data from the UE.

Example Embodiment G15. The method of the previous Example Embodiment, further comprising: at the host, transmitting input data to the client application executing on the UE, the input data being provided by executing the host application, wherein the user data is provided by the client application in response to the input data from the host application.

Example Embodiment G16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, D, E, and F Example Embodiments to transmit the user data from the host to the UE.

Example Embodiment G17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment G18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, D, E, and F Example Embodiments to transmit the user data from the host to the UE.

Example Embodiment G19. The method of the previous Example Embodiment, further comprising, at the network node, transmitting the user data provided by the host for the UE.

Example Emboidment G20. The method of any of the previous 2 Example Embodiments, wherein the user data is provided at the host by executing a host application that interacts with a client application executing on the UE, the client application being associated with the host application.

Example Embodiment G21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, D, E, and F Example Embodiments to transmit the user data from the host to the UE.

Example Embodiment G22. The communication system of the previous Example Embodiment, further comprising: the network node; and/or the user equipment.

Example Embodiment G23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, E, and F Example Embodiments to receive the user data from a user equipment (UE) for the host.

Example Embodiment G24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G25. The host of the any of the previous 2 Example Embodiments, wherein the initiating receipt of the user data comprises requesting the user data.

Example Embodiment G26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, D, E, and F Example Embodiments to receive the user data from the UE for the host.

Example Embodiment G27. The method of the previous Example Embodiment, further comprising at the network node, transmitting the received user data to the host.

1. A method by a first network node for improved UE positioning, the method comprising:
generating at least one positioning related report associated with at least one machine learning, ML, model;
transmitting the at least one positioning related report to a second network node operating as a position generation entity;
receiving, from the second network node, feedback indicating a quality level of the at least one positioning related report; and
performing at least one operation based on the feedback indicating the quality level of the at least one positioning related report.

2. The method of claim 1, wherein, when the feedback is not received from the position generation entity within a time period, performing the at least one operation comprises
discarding data associated with at least one wireless signal received on the uplink channel.

3. The method of claim 1, wherein performing the at least one operation comprises at least one of:
generating or compiling new training data based on the feedback received from the position generation entity; and
transmitting the new training data to a positioning related training data collection entity.

4. The method claim 3, wherein the feedback comprises an indication of a good quality of the at least one positioning related report, and wherein performing the at least one action comprises:
based on the indication of the good quality of the at least one positioning related report, continuing to use the at least one model for determining a location of a User Equipment, UE and/or generation of positioning related reports.

5. The method of claim 3, wherein:
the feedback indicates a poor quality of the at least one positioning related report, and
performing the at least one operation comprises:
generating at least one new training sample based on at least one of: the at least one wireless signal received on the uplink, data associated with the at least one wireless signal, and at least one target positioning related report label; and
adding the at least one new training sample to a training data set.

6. The method claim 5, wherein performing the at least one operation comprises:
based on the poor quality of the at least one positioning related report, deactivating the at least one ML model used for determining a location of the UE and/or generation of the at least one positioning related report.

7. The method claim 5, wherein performing the at least one operation comprises:
based on the poor quality of the at least one positioning related report, updating the at least one ML model used for determining a location of the UE and/or generation of the at least one positioning related report.

8. The method of claim 1, wherein generating the at least one positioning related report comprises:
receiving, from the UE, at least one value associated with at least one measurement performed by the UE based on the wireless signal, and
wherein the at least one positioning related report comprises the at least one value associated with the at least one performed measurement.

9. The method of claim 8, wherein the at least one value comprises at least one of:
an Uplink-Sounding Reference Signal-Reference Signal Received Power, UL SRS-RSRP, value;
an Uplink-Sounding Reference Signal-Reference Signal Received Path Power, UL SRS-RSRPP, value;
a Time of Arrival, ToA, estimation or value;
an Uplink Time Difference of Arrival, UL TDoA, value;
an Uplink Angle of Arrival, UL AoA;
a gNodeB Receive-Transmit, gNB Rx−Tx, time difference value; and
a reception time value.

10. The method of claim 1, wherein the at least one positioning related report comprises:
a UE location estimation;
a time stamp associated with at least one measurement and/or at least one value;
a cell identifier, Cell ID;
a Transmit/Receive Point Identifier, TRP ID;
Synchronization Signal Block, SSB, information;
spatial direction information;
Downlink-Positioning Reference Signal, DL-PRS, configuration information;
Line of Sight, LoS, information;
Non-Line of Sight, NLoS, information; and
a quality estimation value associated with at least one measurement performed on the wireless signal received on the uplink channel.

11. The method of claim 1, wherein providing the at least one positioning related report to the position generation entity comprises transmitting the at least one positioning related report to a second network node operating as a Location Management Function, LMF.

12. The method of claim 1, comprising inputting the at least one wireless signal into the at least one ML model and receiving a location estimate of the UE from the at least one ML model.

13. The method of claim 1, comprising:
performing pre-processing to convert the at least one wireless signal into an input for the at least one ML model;
inputting the converted input into the at least one ML model; and
receiving a location estimate of the UE from the at least one ML model.

14. The method of claim 12, wherein the at least one location estimate comprises at least one Time of Arrival, ToA, estimate.

15. The method of claim 1, wherein the at least one wireless signal comprises at least one SRS.

16. The method of claim 1 wherein the first network node comprises: a base station: a gNodeB; a Transmit/Receive Point, TRP; or a reception point.

17. A method by a second network node operating as a position generating entity for improved assisted positioning, the method comprising:
receiving, from a first network node operating as a position related report generation entity, a first set of positioning related reports generated based on at least one wireless signal transmitted on a downlink channel;
based on the first set of positioning related reports, determining a location of a User Equipment, UE; and
transmitting feedback to the first network node operating as the position related report generation entity, wherein the feedback indicates a quality of the at least one positioning related report.

18. The method of claim 17, wherein determining the location of the UE comprises:
based on the first set of positioning related reports, performing positioning computation to obtain a first UE position estimate;
based on a respective compatibility scores for each positioning related report in the first set of positioning related reports, identifying:
a second set of positioning related reports having compatibility scores that are better than a compatibility threshold, and
a third set of positioning related reports having compatibility scores that are not better than the compatibility threshold; and
transmitting, to the first network node, a notification that the third set of positioning reports is associated with compatibility scores that are not better than the compatibility threshold.

19.-30. (canceled)

31. A first network node for improved UE positioning, the first network node configured to:
generate at least one positioning related report associated with at least one machine learning, ML, model;
transmit the at least one positioning related report to a second network node operating as a position generation entity;
receive, from the second network node, feedback indicating a quality level of the at least one positioning related report; and
perform at least one operation based on the feedback indicating the quality level of the at least one positioning related report.

32. (canceled)

33. A second network node operating as a position generating entity for improved positioning, the second network node configured to:
receive, from a first network node operating as a position related report generation entity, a first set of positioning related reports generated based on at least one wireless signal transmitted on a downlink channel;
based on the first set of positioning related reports, determine a location of a User Equipment, UE; and
transmit feedback to the first network node operating as the position related report generation entity, wherein the feedback indicates a quality of the at least one positioning related report.

34. (canceled)
